(19) United States
(12) Patent Application Publication
(10) Pub. No.: US 2026/0310226 A1
(43) Pub. Date: Oct. 8, 2026

(54) MULTI-DRONE SYSTEMS AND METHODS

(71) Applicant: UAVPatent Corp., Carson City, NV (US)

(72) Inventors: George MATUS, Salt Lake City, UT (US); Manuel LÓPEZ, East Palo Alto, CA (US); Allan EVANS, San Juan, PR (US)

(73) Assignee: UAVPatent Corp., Carson City, NV (US)

(21) Appl. No.: 18/998,429

(22) PCT Filed: Jul. 24, 2023
(86) PCT No.: PCT/US2023/028443

§ 371 Date: Jan. 24, 2025

Related U.S. Application Data
(60) Provisional application No. 63/369,345, filed on Jul. 25, 2022.

(51) Int. Cl. G05D 1/65; B64U 50/37; G05D 1/661; G05D 1/698; G05D 109/25

(52) U.S. Cl. CPC G05D 1/651; B64U 50/37; G05D 1/661; G05D 1/6983; G05D 2109/254

(57) ABSTRACT

A system may include a plurality of unmanned aerial vehicles (UAVs), the plurality of UAVs including a first UAV and a second UAV. The system may include at least one recharging station and a ground station configured to, during a mission: autonomously coordinate replacement of the first UAV by the second UAV. A method may be performed during a mission by an unmanned aerial system (UAS) including a plurality of UAVs and at least one recharging station. The method may include, without human assistance: causing a first UAV flying the mission to be replaced by a second UAV; and causing the first UAV to fly to a particular recharging station of the at least one recharging station.

### CROSS-REFERENCE TO RELATED APPLICATIONS

This application claims priority to, and hereby incorporates by reference in its entirety for all purposes, U.S. provisional Application No. 63/369,345, filed Jul. 25, 2022 and entitled “Multi-Drone Systems and Methods” (Attorney Docket No. UAVP002P).

### BACKGROUND

Unmanned aerial vehicles (UAVs), also referred to as drones, can be used for a variety of purposes. These purposes include, for example, surveillance, deliveries, sport (e.g., drone racing), aerial photography (e.g., real estate marketing), and surveying (e.g., farm fields). Depending on the application, a UAV might carry peripherals (e.g., a camera, sonar system, etc.). A UAV might need to send data to (e.g., gathered/sensed data) or receive information from (e.g., control information, instructions, etc.) a ground station.

One application of UAVs is in the identification of objects and/or the determination of locations of objects (e.g., on the ground). Photogrammetry is a technique that can be used by a single UAV to determine the position of an object or a region. For example, a UAV camera can take two (or more) photographs of an object or region while flying. Relative orientation can then be performed on two images taken by the UAV camera, and photogrammetry can be carried out by performing absolute orientation of the images based on known points (points having a geocentric coordinate already known). Photogrammetry can work well as long as the object being identified remains still between images. If the object moves between images, the accuracy of the relative orientation decreases, and it might not be possible to perform the relative orientation in some situations. In addition, it is necessary to have a good estimate of the location of the UAV for each image in order to perform ground orientation (absolute orientation).

To determine the position of a UAV in three-dimensional space, an unmanned aerial system (UAS) typically relies on a navigation system. Conventional techniques used for UAV navigation are generally based on two fundamental methods: position fixing and dead reckoning.

Position fixing techniques rely on devices, such as cameras and/or more sophisticated systems (e.g., the Global Navigation Satellite System (GNSS)), that measure physical properties external to the UAV. Position fixing measurements may determine the position of the UAV by measuring or estimating the distance to specified points (e.g., landmarks (e.g., using a camera), satellites (e.g., using GNSS), etc.), the position of the Sun or stars, the Earth's magnetic field, atmospheric properties, incoming airspeed velocity and orientation, the location of the horizon, the height of the UAV over terrain, etc. The term “velocity” as used herein refers to both speed and direction of travel.

Dead reckoning is the process of calculating a current position by using a previously-determined position and advancing that position based upon known or estimated accelerations and/or speeds over an elapsed amount of time and a course. A dead reckoning position solution is effectively a sum of a series of relative position measurements. Dead reckoning techniques rely on measurements of physical processes intrinsic to the UAV, such as accelerations and angular speeds.

To provide dead reckoning, UA Vs can include an inertial navigation system (INS). An INS is a navigation system that operates based on the principles of inertia and the laws of motion. It uses inertial sensors to determine the position, orientation, and velocity of a moving object without relying on external references such as GPS or landmarks. By integrating the acceleration measurements over time, the system calculates the UAV's velocity in three dimensions, and by integrating the angular rate measurements over time, the system determines changes in the UAV's orientation (attitude) over time.

The INS may include one or more sensors, such as solid-state accelerometers, gyros, magnetometers, static/dynamic pressure sensors, and/or any other inertial measurement units (IMUs) that take into consideration geometric and kinematic relationships. The INS can use linear and angular velocities and accelerations from the sensor(s) to estimate the position, orientation, and/or velocity of the UAV.

Each of the sensors of a system used for dead reckoning (e.g., an INS) is subject to error. The sensor errors are due to, for example, system noise, bias, scaling, quantization, non-orthogonality, temperature, etc. These errors can be considerable, and they can vary significantly depending upon the qualities and properties of the sensors and navigation algorithms, and environmental conditions. In addition, error magnitudes and causes can be different in different directions (e.g., errors in the azimuth direction can be larger or smaller than errors in the elevation direction, etc.). Together, the errors in three-dimensional space form a volume of spatial uncertainty where the UAV might be. This volume can be referred to as a spatial uncertainty cloud.

Over time, the errors in dead reckoning systems accumulate, resulting in what is sometimes referred to as “drift.” Thus, the spatial uncertainty cloud generally grows in volume and/or changes shape as time passes. In contrast, position fixing does not suffer from error accumulation because position fixing systems rely on components external to the UAV.

Therefore, a UAV's navigation system often combines measurements from an INS and absolute reference information from an external system (e.g., a GPS) to determine and/or monitor the position of the UAV. For example, the navigation system may fuse the absolute position, velocity, and time information provided by a GPS sensor with a dead reckoning position provided by an INS. The position (location), trajectory, velocity, angular orientation, etc. of the UAV may be estimated based on the combined data.

In general, the INS measurement frequency is much higher than the measurement frequency of GPS, and therefore the INS provides the reference trajectory (determined by the on-board sensors), and the GPS serves as an updating system. In other words, the GPS measurements provide an external aid that resets (or reduces the error in, or corrects) the position and velocity estimates determined from the measurements of the INS. Such a combined GPS/INS system works well as long as the GPS provides a valid position, velocity, and time solution to limit the drift inherent to the accelerometers, the gyroscopes, and other IMUs of the INS.

Sometimes, however, information from a position fixing system is not continuously available, or GPS signals are not available at all or are insufficient to obtain accurate data (e.g., position, orientation, speed, trajectory, etc.). For example, a GPS signal might not be obtainable, or the GPS signal might be relatively weak (e.g., insufficient). Such environments, which are referred to herein as “GPS-denied” environments, may be caused by a variety of factors, such as terrain, weather, radio frequency interference (RFI), intentional jamming (e.g., a spoofing attack, a malicious jammer, etc.), etc. In such circumstances, a UAV's navigation system may revert to using a dead reckoning navigation technique that relies solely on the measurements from the INS. In this mode, linear accelerations and velocities are integrated without the measurement corrections that would otherwise be provided by the position fixing system. As a result, a drift in the position estimate is inevitable due to cumulative errors.

In addition to navigation challenges, UASs face other challenges, including limited UAV battery life, which limits flight range and/or time a UAV can remain airborne. Another challenge is ensuring that UAVs are able to communicate data successfully over long distances, such as to a ground station. It will be appreciated that a longer battery life may lead to greater flight range from a ground station, which may lead to a need for a UAV to be able to communicate successfully over even longer distances.

Yet another challenge is for a UAS to be able to gather all of the data or information that is desired. It will be appreciated that a UAV carrying multiple data-gathering instruments (e.g., multiple cameras, sonar, etc.) may have, due to its weight/bulk, reduced battery life, reduced flight time, etc.

### SUMMARY

This summary represents non-limiting embodiments of the disclosure.

Disclosed herein are systems and methods that use multiple UAVs to provide significant improvements to UASs by addressing some or all of the above-described problems. Some of the improvements relate to navigation/position estimation and/or object identification, whereas others relate to battery life, communication, and/or modularity. Some of the disclosures will be particularly beneficial in GPS-denied environments, but it is to be understood that the disclosures are not limited to GPS-denied environments. In general, the systems, methods, and techniques described herein can be used in any UAV or UAS environment.

In some aspects, the techniques described herein relate to an unmanned aerial system (UAS), including: a plurality of unmanned aerial vehicles (UAVs), the plurality of UAVs including a first UAV and a second UAV; at least one recharging station; and a ground station configured to, during a mission: autonomously coordinate replacement of the first UAV by the second UAV.

In some aspects, a capability of the second UAV differs from a capability of the first UAV.

In some aspects, autonomously coordinating the replacement of the first UAV by the second UAV includes the ground station transmitting an activation signal to the second UAV.

In some aspects, transmitting the activation signal is in response to at least one of: a detected battery level of the first UAV, an estimated battery level of the first UAV, an elapsed amount of time, an estimated remaining flight time of the first UAV, an estimated remaining flight time in the mission, an estimated remaining flight distance in the mission, a predicted position of a target, an observation of the target, or a predicted arrival time of the target.

In some aspects, autonomously coordinating the replacement of the first UAV by the second UAV is based at least in part on information retrieved from the first UAV.

In some aspects, the ground station is further configured to retrieve the information retrieved from the first UAV.

In some aspects, the information retrieved from the first UAV includes information about at least one of: a battery level, a power level, an estimated flight time, an observation, a target, a landmark, or a temperature.

In some aspects, autonomously coordinating the replacement of the first UAV by the second UAV is based at least in part on information gathered by the UAS prior to a beginning of the mission.

In some aspects, the information gathered by the UAS prior to the beginning of the mission includes data from a sensor, geographic data, or information about at least one of: a battery level, a power level, a flight time, an observation, a temperature, a rate of battery depletion, an object, a landmark, or a route taken by a target.

In some aspects, autonomously coordinating the replacement of the first UAV by the second UAV is based at least in part on a detected or predicted pattern of behavior.

In some aspects, autonomously coordinating the replacement of the first UAV by the second UAV is based at least in part on information about at least one of the first UAV or the second UAV. In some aspects, the information about at least one of the first UAV or the second UAV includes a make, a model, a serial number, a position, a battery level, a hardware configuration, an expected flight time, a software configuration, or a communication capability.

In some aspects, autonomously coordinating the replacement of the first UAV by the second UAV is based at least in part on information about an object or event detected by at least one of the first UAV, the second UAV, a third UAV of the UAS, or a source external to the UAS. In some aspects, the information about the object or event detected by at least one of the first UAV, the second UAV, a third UAV of the UAS, or a source external to the UAS includes information about at least one of an object, a target, or a landmark.

In some aspects, autonomously coordinating the replacement of the first UAV by the second UAV includes: determining a first flight plan for the first UAV; determining second flight plan for the second UAV; sending the first flight plan to the first UAV; and sending the second flight plan to the second UAV.

In some aspects, autonomously coordinating the replacement of the first UAV by the second UAV further includes: instructing the second UAV to execute the second flight plan at a first specified time or after a first specified delay; and instructing the first UAV to execute the first flight plan at a second specified time, the second specified time being after the first specified time, or after a second specified delay, the second specified delay being larger than the first specified delay.

In some aspects, the second UAV is configured to execute the second flight plan after a first specified delay, and the first UAV is configured to execute the first flight plan after a second specified delay, the second specified delay being larger than the first specified delay.

In some aspects, the first flight plan includes first information instructing the first UAV when to begin executing the first flight plan, and the second flight plan includes second information instructing the second UAV when to begin executing the second flight plan.

In some aspects, the first information instructs the first UAV to begin executing the first flight plan at a first time, and the second information instructs the second UAV to begin executing the second flight plan at a second time, the second time being earlier than the first time.

In some aspects, determining the first flight plan for the first UAV and/or determining the second flight plan for the second UAV accounts for a current condition.

In some aspects, the current condition is one or more of: a weather condition, a battery level of the first UAV, a battery level of the second UAV, a position of the first UAV, a position of the second UAV, a recharge station occupancy, a position of a particular recharge station of the at least one recharge station, or presence or absence of an object or event detected by at least one of the first UAV, the second UAV, a third UAV of the UAS, or a source external to the UAS.

In some aspects, autonomously coordinating the replacement of the first UAV by the second UAV further includes: the ground station instructing the second UAV to replace the first UAV, and wherein the first UAV and the second UAV are configured to carry out the instruction without assistance from the ground station.

In some aspects, autonomously coordinating the replacement of the first UAV by the second UAV is based at least in part on at least one of: a battery level of the first UAV, a power level of the first UAV, an estimated flight time of the first UAV, an observation a target, a landmark, or a temperature.

In some aspects, the first UAV and the second UAV are configured to communicate with each other to avoid collisions and/or to transfer information.

In some aspects, the first UAV and the second UAV are configured to communicate with each other through the ground station, and wherein the ground station is further configured to relay messages between the first UAV and the second UAV.

In some aspects, the first UAV and the second UAV are configured to maintain at least a specified separation distance between them during a replacement operation through which the second UAV replaces the first UAV.

In some aspects, autonomously coordinating the replacement of the first UAV by the second UAV includes: verifying that the second UAV is in position to replace the first UAV, and switching a feed from the first UAV to the second UAV. In some aspects, the feed includes at least one of a video feed, a data feed, or a control feed.

In some aspects, autonomously coordinating the replacement of the first UAV by the second UAV further includes: instructing the first UAV to fly to a selected recharging station of the at least one recharging station.

In some aspects, the at least one recharging station includes a plurality of recharging stations, and the ground station is further configured to, during the mission: autonomously select a particular recharging station of the plurality of recharging stations for use by the first UAV after its replacement by the second UAV.

In some aspects, one or more of the plurality of recharging stations has a variable location. In some aspects, the one or more of the plurality of recharging stations is situated in or on a vehicle. In some aspects, the one or more of the plurality of recharging stations is situated on a movable platform.

In some aspects, autonomously selecting the particular recharging station of the plurality of recharging stations for use by the first UAV after its replacement by the second UAV is based at least in part on information retrieved from the first UAV.

In some aspects, the ground station is further configured to retrieve the information retrieved from the first UAV. In some aspects, the information retrieved from the first UAV includes a battery level, a power level, an estimated flight time, an observation, or a temperature.

In some aspects, autonomously selecting the particular recharging station of the plurality of recharging stations for use by the first UAV after its replacement by the second UAV is based at least in part on at least one of: a battery level of the first UAV, a power level of the first UAV, an estimated flight time of the first UAV, an observation, a target, a landmark, or a temperature.

In some aspects, a number of the plurality of UAVs is not equal to a number of the at least one recharging station.

In some aspects, the number of the plurality of UAVs exceeds the number of the at least one recharging platform.

In some aspects, the plurality of UAVs includes a third UAV and a fourth UAV, and the ground station is further configured to, during the mission: autonomously coordinate replacement of the third UAV by the fourth UAV.

In some aspects, each of the first UAV and the second UAV includes a first hardware component but not a second hardware component, and each of the third UAV and the fourth UAV includes the second hardware component but not the first hardware component.

In some aspects, the plurality of UAVs includes a third UAV, and wherein the ground station is further configured to, during the mission: autonomously coordinate replacement of the second UAV by the third UAV.

In some aspects, the ground station includes: a processor configured to execute machine-executable instructions for autonomously coordinating replacement of the first UAV by the second UAV; and memory storing the machine-executable instructions.

In some aspects, the techniques described herein relate to a method performed during a mission by an unmanned aerial system (UAS) including a plurality of unmanned aerial vehicles (UAVs) and at least one recharging station, the method including, without human assistance: causing a first UAV flying the mission to be replaced by a second UAV; and causing the first UAV to fly to a particular recharging station of the at least one recharging station.

In some aspects, causing the first UAV flying the mission to be replaced by the second UAV includes handing over responsibility for data collection and/or provision to the second UAV.

In some aspects, causing the first UAV flying the mission to be replaced by the second UAV includes the second UAV executing a flight plan.

In some aspects, the techniques described herein relate to a method, further including a ground station providing the flight plan to the second UAV.

In some aspects, the techniques described herein relate to a method, further including the first UAV requesting a replacement UAV, and wherein causing the first UAV flying the mission to be replaced by the second UAV is in response to the first UAV requesting the replacement UAV.

In some aspects, the at least one recharging station includes a plurality of recharging stations including the particular recharging station, and the method further includes: selecting the particular recharging station for the first UAV to use.

In some aspects, a capability of the second UAV differs from a capability of the first UAV.

In some aspects, causing the first UAV flying the mission to be replaced by the second UAV includes a ground station transmitting an activation signal to the second UAV.

In some aspects, transmitting the activation signal is in response to at least one of: a detected battery level of the first UAV, an estimated battery level of the first UAV, an elapsed amount of time, an estimated remaining flight time of the first UAV, an estimated remaining flight time in the mission, an estimated remaining flight distance in the mission, a predicted position of a target, or a predicted arrival time of the target.

In some aspects, causing the first UAV flying the mission to be replaced by the second UAV is based at least in part on information retrieved from the first UAV.

In some aspects, the techniques described herein relate to a method, further including a ground station of the UAS retrieving the information retrieved from the first UAV. In some aspects, the information retrieved from the first UAV includes information about at least one of: a battery level, a power level, an estimated flight time, an observation, a target, a landmark, or a temperature.

In some aspects, causing the first UAV flying the mission to be replaced by the second UAV is based at least in part on information gathered by the UAS prior to a beginning of the mission.

In some aspects, the information gathered by the UAS prior to the beginning of the mission includes data from a sensor, geographic data, or information about at least one of: a battery level, a power level, a flight time, an observation, a temperature, a rate of battery depletion, an object, a landmark, or a route taken by a target.

In some aspects, causing the first UAV flying the mission to be replaced by the second UAV is based at least in part on a detected or predicted pattern of behavior.

In some aspects, causing the first UAV flying the mission to be replaced by the second UAV is based at least in part on information about at least one of the first UAV or the second UAV. In some aspects, the information about at least one of the first UAV or the second UAV includes a make, a model, a serial number, a position, a battery level, a hardware configuration, an expected flight time, a software configuration, or a communication capability.

In some aspects, causing the first UAV flying the mission to be replaced by the second UAV is based at least in part on information about an object or event detected by at least one of the first UAV, the second UAV, a third UAV of the UAS, or a source external to the UAS. In some aspects, the information about the object or event detected by at least one of the first UAV, the second UAV, a third UAV of the UAS, or a source external to the UAS includes information about at least one of an object, a target, or a landmark.

In some aspects, causing the first UAV flying the mission to be replaced by the second UAV includes: determining a first flight plan for the first UAV; determining second flight plan for the second UAV; sending the first flight plan to the first UAV; and sending the second flight plan to the second UAV.

In some aspects, causing the first UAV flying the mission to be replaced by the second UAV further includes: instructing the second UAV to execute the second flight plan at a first specified time or after a first specified delay; and instructing the first UAV to execute the first flight plan at a second specified time, the second specified time being after the first specified time, or after a second specified delay, the second specified delay being larger than the first specified delay.

In some aspects, the techniques described herein relate to a method, further including: the second UAV executing the second flight plan after a first specified delay; and the first UAV executing the first flight plan after a second specified delay, the second specified delay being larger than the first specified delay.

In some aspects, the first flight plan includes first information instructing the first UAV when to begin executing the first flight plan, and the second flight plan includes second information instructing the second UAV when to begin executing the second flight plan.

In some aspects, the first information instructs the first UAV to begin executing the first flight plan at a first time, and the second information instructs the second UAV to begin executing the second flight plan at a second time, the second time being earlier than the first time.

In some aspects, determining the first flight plan for the first UAV and/or determining the second flight plan for the second UAV accounts for a current condition. In some aspects, the current condition is one or more of: a weather condition, a battery level of the first UAV, a battery level of the second UAV, a position of the first UAV, a position of the second UAV, a recharge station occupancy, a position of a particular recharge station of the at least one recharge station, or presence or absence of an object or event detected by at least one of the first UAV, the second UAV, a third UAV of the UAS, or a source external to the UAS.

In some aspects, causing the first UAV flying the mission to be replaced by the second UAV includes: a ground station instructing the second UAV to replace the first UAV; and the first UAV and the second UAV carrying out the instruction without assistance from the ground station.

In some aspects, causing the first UAV flying the mission to be replaced by the second UAV is based at least in part on one or more of: a battery level of the first UAV, a power level of the first UAV, an estimated flight time of the first UAV, an observation, a target, a landmark, or a temperature.

In some aspects, the techniques described herein relate to a method, further including: the first UAV and the second UAV communicating with each other. In some aspects, the first UAV and the second UAV communicating with each other includes sending messages to a ground station, and wherein the method further includes the ground station relaying the messages between the first UAV and the second UAV.

In some aspects, the techniques described herein relate to a method, further including: the first UAV and the second UAV maintaining at least a specified separation distance between them during a replacement operation through which the second UAV replaces the first UAV.

In some aspects, causing the first UAV flying the mission to be replaced by the second UAV includes: verifying that the second UAV is in position to replace the first UAV, and switching a feed from the first UAV to the second UAV. In some aspects, the feed includes at least one of a video feed, a data feed, or a control feed.

In some aspects, the particular recharging station is one of a plurality of recharging stations, and further including: autonomously selecting the particular recharging station from among the plurality of recharging stations for use by the first UAV after its replacement by the second UAV.

In some aspects, autonomously selecting the particular recharging station from among the plurality of recharging stations for use by the first UAV after its replacement by the second UAV is based at least in part on information retrieved from the first UAV.

In some aspects, the techniques described herein relate to a method, further including: a ground station retrieving the information retrieved from the first UAV. In some aspects, the information retrieved from the first UAV includes information about at least one of: a battery level, a power level, an estimated flight time, an observation, a target, a landmark, or a temperature.

In some aspects, autonomously selecting the particular recharging station from among the plurality of recharging stations for use by the first UAV after its replacement by the second UAV is based at least in part on at least one of: a battery level, a power level, an estimated flight time, an observation, a target, a landmark, or a temperature.

The description below is divided into sections for convenience of explanation. It is to be understood that the disclosures in different sections can be used together, whether or not explicitly stated in the individual sections and/or in the claims. It is also to be understood that the headings are for convenience and are not intended to be limiting.

### BRIEF DESCRIPTION OF THE DRAWINGS

Objects, features, and advantages of the disclosure will be readily apparent from the following description of certain embodiments taken in conjunction with the accompanying drawings in which:

FIG. 1 illustrates a UAS in accordance with some embodiments.

FIGS. 2A, 2B, 2C, and 2D illustrate the two UAVs flying in formation and making changes to their vectors in accordance with some embodiments.

FIG. 2E is a flow diagram illustrating a method that can be performed by a UAS in accordance with some embodiments.

FIG. 2F is a flow diagram of another method that can be performed by a UAS in accordance with some embodiments.

FIGS. 3A, 3B, 3C, 3D, and 3E illustrate examples of a UAS that includes a ground station and a plurality of UAVs in accordance with some embodiments.

FIGS. 4A, 4B, and 4C illustrate a UAS with multiple recharging stations situated in different physical locations in accordance with some embodiments.

FIG. 4D is a flow diagram illustrating a method that can be performed without human assistance (autonomously) during a mission by a UAS in accordance with some embodiments.

FIG. 4E is a flow diagram illustrating an example of a method of causing a first UAV to be replaced by a second UAV using flight plans in accordance with some embodiments.

FIG. 4F is a flow diagram illustrating an example of a method of causing a first UAV to be replaced by a second UAV when the first UAV is providing a feed in accordance with some embodiments.

FIG. 5 is an example of a UAS that includes UAVs configured to implement a communication network.

FIG. 6 is an example of a UAV with components that can be used to carry out the systems and methods described herein.

To facilitate understanding, identical reference numerals have been used, where possible, to designate identical elements that are common to the figures. It is contemplated that elements disclosed in one embodiment may be beneficially utilized in other embodiments without specific recitation. Moreover, the description of an element in the context of one drawing is applicable to other drawings illustrating that element.

### DETAILED DESCRIPTION

Systems and methods described herein use multiple UAVs to provide significant improvements to UASs. Some of the improvements relate to navigation/position estimation and/or object identification, whereas others relate to battery life, communication, and/or modularity. In general, the systems, methods, and techniques described herein can be used in any UAV or UAS environment.

At least part of the devices (e.g., modules or functions) of the UAS or methods (e.g., operations) performed by the UAS or its components according to various embodiments may be embodied as one or more machine-executable instructions stored in a non-transitory computer readable medium (e.g., as a program module). When the one or more machine-executable instructions is/are executed by a processor, the processor may perform a function corresponding to the one or more instructions, or it may cause (e.g., instruct) another hardware element to perform a function. The one or more machine-executable instructions may be stored in a non-transitory computer-readable medium and read and executed by a computer to implement one or more embodiments. A non-transitory readable recording medium is a medium that stores data and is capable of being read by a machine (e.g., a device such as a processor). Non-transitory computer-readable media include registers, caches, buffers, CDs, DVDs, hard disks, Blu-ray disks, USB storage media, internal memory, memory cards, read-only memory (ROM), or random-access memory (RAM), but not transmission media such as signal, current, or the like.

The methods described herein may be provided as a computer program product. A computer program product may include a software program, a computer-readable storage medium in which the software program is stored, or a merchandise traded between a seller and a purchaser. For example, a computer program product can include a product in the form of a software program (e.g., a downloadable app) distributed on-line through a manufacture and an electronic market (e.g., Google play store, Apple app store, etc.) or via over-the-air distribution. In the case of on-line or over-the-air distribution, at least a portion of the software program may be stored in a storage medium, or temporarily created. In this case, a storage medium may be a storage medium of a server of a manufacturer or an electronic market, a relay server, or similar.

### A. Estimating the Distance Between UAVs

The techniques described herein use a plurality of (i.e., two or more) UAVs. As discussed further below, some embodiments can benefit from the distance between different UAVs being known to sufficient accuracy. For example, the performance of various techniques can be improved if the distance between a first UAV and a second UAV is known or can be estimated to a sufficient level of precision.

There are many ways to determine or estimate the distance between two UAVs. This section describes several of these ways, but it is to be appreciated that other approaches are also suitable and are not excluded, even if not explicitly described herein. Thus, when this document refers to determining the distance between two UAVs, it is to be appreciated that any of the approaches specifically described can be used (unless context indicates otherwise), or, alternatively or in addition, any other suitable approach can be used.

One way to estimate the distance between a first UAV and a second UAV is using information from an external system (e.g., GPS, etc.). For example, if the first UAV obtains a first set of position, velocity, and time data from an external system, and the second UAV obtains a second set of position, velocity, and time data from the same or a different external system, the distance between the two UAVs can be determined using this data (e.g., taking into account any movement that might have occurred since the data was obtained).

Other approaches may be used instead of or in addition to using data from an external system. For example, as described above, the first and second UAVs may be in a GPS-denied environment, in which case an approach that does not rely on a GPS can be used instead.

One way to determine the distance between a first UAV and a second UAV in a GPS-denied environment (or even in an environment in which GPS is available) is to attach the first and second UAVs to a shared object that results in a deterministic (e.g., fixed or calculable) distance between the two UAVs. Thus, when the two UAVs are attached to the shared object, the distance between the UAVs can be determined or is known. For example, the first UAV can be attached to a first end of a rigid strut or frame having known dimensions, and the second UAV can be attached to the second end of the rigid strut or frame. With the first and second UAVs so attached, the distance between them is known because the length of the strut or distance between the two attachments points of the frame is known.

As another example, the first and second UAVs can be connected to respective ends of a flexible cord (e.g., via hooks, magnets, knots, etc.). Once attached to the flexible cord, the first and second UAVs can fly away from each other until the cord is taut, at which point the distance between the first and second UAVs is known because the length of the cord between the UAVs' attachment points is known.

Another way to estimate the distance between a first UAV and a second UAV is by using known physical characteristics of the UAVs. For example, if the first UAV knows the size of the second UAV (and/or vice versa), it can estimate the distance between the two UAVs by detecting the apparent size of the second UAV at the distance using, for example, an optical camera aimed at the second UAV.

As another example of using physical properties, each UAV can include a physical characteristic (e.g., a shape, a circle, a word, an alphanumeric character, a logo, a pattern, a code (e.g., a QR code or bar code), a color, a reflector, etc.) that is known to the other UAV(s) in the UAS. This physical characteristic can be detected by a component of the other UAV(s). As a specific example, each UAV can include a logo on its body, where the characteristics of the logo (e.g., any or all of its size, its position, its color, etc.) and the physical dimensions of the UAV are known. The first UAV can include an optical camera, which it can aim at the second UAV to discover the logo. If the logo on the second UAV is not visible to the first UAV's camera, the second UAV can change its orientation (e.g., rotate, etc.) until its logo is visible to the first UAV's camera. Because the first UAV knows at least some characteristic(s) of the logo on the second UAV (e.g., its size, its position, its color, etc.), the first UAV can determine from the detected characteristics (e.g., the size) how far away the second UAV is and/or the orientation of the second UAV in space (e.g., using image processing techniques). Similar techniques can rely on processing images taken by thermal cameras.

Another way to estimate the distance between a first UAV and a second UAV is using audio cues. For example, a first UAV can detect an audio signal emitted by a second UAV. If the first UAV has information about an audible signal (e.g., one or more of pattern, volume, power level, etc.), it can estimate its distance to the second UAV based on this information.

Another way to estimate the distance between a first UAV and a second UAV is using UAV-emitted signals. For example, each UAV can include a transmitter and receiver (e.g., infrared, radio-frequency (RF), radar, sonar, etc.). The first UAV can emit a signal (e.g., infrared, RF, radar, sonar, etc.) and detect either a reflection of that signal off of the second UAV (e.g., in the case of radar or sonar) or a response to that signal (e.g., in the case of RF) from the second UAV. The first UAV can estimate the distance to the second UAV based on the time of flight of the emitted signal or based on the response signal. Alternatively, or in addition, the second UAV can measure received signal strength or power (e.g., RSSI). The UAV-emitted signals can be any suitable signals, such as, for example, light pulse sequences or digitized RF sequences (e.g., a gold code or similar). In some embodiments, each UAV in a swarm or team uses a different sequence so that the signals emitted by different UAVs have low cross-correlation with each other so that each UAV's signal can be detected more easily in the presence of every other UAV's signal.

Another approach to estimate the distance between UAVs is to take advantage of signal time-of-arrival differentials. For example, a first UAV can emit both an audio signal and an RF signal at the same time (or during the same period). A second UAV can detect both the audio signal, which will have traveled at the speed of sound, and the RF signal, which will have traveled at the speed of light. The second UAV can estimate the distance using both of the signals and taking into account the differences in arrival time.

It is to be appreciated that when a UAS relies on UAV-emitted signals, it is not necessary for all of the UAVs to have the same signal transmission/detection capabilities. For example, one UAV can include a radar or sonar system that can be used to detect the presence of and positions of other UAVs in the UAS. The other UAVs do not need to include corresponding radar or sonar equipment. Instead, the UAV that includes the radar or sonar equipment (the “probe UAV”) can take into account how many other UAVs are in the UAS and any a priori knowledge of where those other UAVs are supposed to be relative to the probe UAV.

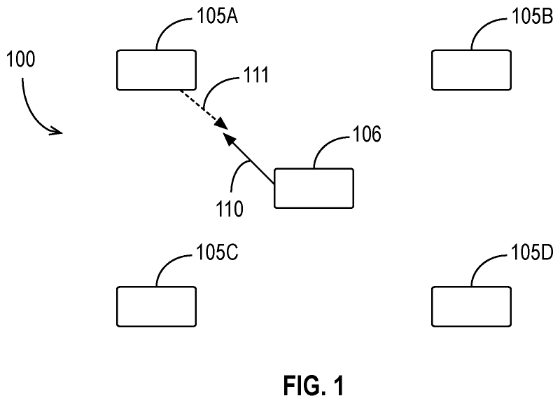

For example, a UAS 100 may include five UAVs 105 flying in a configuration such as that illustrated in FIG. 1. The probe UAV 106 can use an onboard system to scan for the UAV 105A, UAV 105B, UAV 105C, and UAV 105D. As an example, the probe UAV 106 can emit a signal 110 in the direction of where it expects the UAV 105A to be. The detected reflection(s) 111 can be used to estimate the position of the UAV 105A (e.g., the time of flight can be used to determine the distance between the probe UAV 106 and the UAV 105A, and the angle of arrival can be used to determine the direction of the UAV 105A from the probe UAV 106). The probe UAV 106 can emit similar directional signals to determine the positions of the UAV 105B, UAV 105C, and UAV 105D. The distances between the various UAVs 105 can then be determined from the positions of the UAVs 105.

It will be appreciated that UAVs 105 can combine two or more of the above-described approaches to improve the distance estimate(s).

### B. Using Multiple UAVs to Reduce Uncertainty in UAV Position Estimates

The location of a single UAV in space can be determined in a GPS-denied environment using trigonometry. For example, a UAV equipped with a camera (e.g., optical, thermal, etc.) can direct its camera at an object that has a known location (e.g., a landmark). Given the orientation of the UAV in space (e.g., its approximate altitude and the direction in which the camera is pointed), the approximate location of the UAV can be determined using, e.g., trigonometric ratios (e.g., cos(0)=x/h, where x is the altitude of the UAV, 0 is the angle of the camera relative to vertical, and h is the distance from the UAV to the (presumed flat) ground along the direction in which the camera is pointed. As will be appreciated by those having ordinary skill in the art, other geometric and/or trigonometric relationships can be used to determine the approximate location of a single UAV relative to an object with a known location (e.g., taking into account the characteristics of the ground, etc.). This approach can be extended and improved by the UAV remaining stationary (e.g., hovering in a fixed position) and using multiple landmarks for the estimate. The use of one or more additional landmarks allows the UAV to refine its estimate of its position.

To improve estimates of UAV positions by using multiple UAVs, in some embodiments, multiple UAVs and binocular stereoscopic image data are used to determine the UAVs' positions more accurately than could otherwise be determined for a single UAV. For example, a first UAV can collect first image data from its perspective, and a second UAV can collect second image data from its perspective at substantially the same time as the first UAV. A distance computation unit can use the image data from the two perspectives to calculate a parallax angle of each of corresponding points of the two images represented by the image data and calculate a relative position of each UAV within three-dimensional space. The accuracy of the estimates can be improved if the distances between the UAVs are known to sufficient precision (e.g., as described in Section A above, or using any other suitable approach).

The accuracy of the estimates can also be improved by using multiple landmarks. For example, a first UAV can collect first image data of a first landmark and first image data of a second landmark from its perspective, and a second UAV can collect second image data of the first landmark and second image data of the second landmark from its perspective at substantially the same time as the first UAV. The distance computation unit can use the image data (for each of the two landmarks) from the two perspectives to calculate a parallax angle of each of corresponding points of the two images (per landmark) represented by the image data and calculate a relative position of each UAV within three-dimensional space. It is to be appreciated that more than two landmarks can be used, and that, generally speaking, the accuracy of the estimates will improve as more landmarks are used.

The distance computation unit can be located in the first UAV, in the second UAV, in a ground station (e.g., a control unit), or in some combination of the first UAV, the second UAV, and the ground station. The first and/or second UAV may include hardware and/or software allowing them to transmit and/or receive the image data they collect.

The estimated positions determined by the distance computation unit can be combined (e.g., fused) with geometry/trigonometry-based position estimates determined independently for the first UAV and the second UAV. The fusion process can reduce the region of uncertainty of (e.g., noise in) the position estimates.

The relative positions and/or orientations of the first UAV and the second UAV can be modified to improve the position estimates. For example, at a first time, the first UAV and the second UAV can be at approximately the same altitude and at a first distance from each other when they capture a first set of image data. At a second time, the first UAV and the second UAV can be at different altitudes and/or at a different distance from each other and/or at different orientations when they capture a second set of image data. The changes in relative position and/or orientation provide changing stereoscopic estimates that can reduce the noise in the position estimates (e.g., assuming the noise is uncorrelated).

The accuracy of the estimates of the UAV positions can be improved further by using image data from more than two UAVs (e.g., also using a third UAV, or a third and fourth UAV, etc.). This additional image data can be used to reduce the noise in the position estimates (e.g., assuming the noise is uncorrelated). For example, if a UAS includes a first UAV, a second UAV, and a third UAV, and each of the first, second, and third UAVs is equipped with an optical camera, the first UAV may capture first optical image data at a first time, the second UAV may capture second optical image data at the first time, and the third UAV may capture third optical image data and the first time. The first and second optical image data can be used to calculate a parallax angle corresponding to the first and second UAVs and calculate a relative position of each of the first UAV and the second UAV within three-dimensional space (a first estimate of the first UAV position and a first estimate of the second UAV position). Similarly, the second and third optical image data can be used to calculate a parallax angle corresponding to the second and third UAVs and calculate a relative position of each of the second UAV and the third UAV within three-dimensional space (a second estimate of the second UAV position and a first estimate of the third UAV position). Likewise, the first and third optical image data can be used to calculate a parallax angle corresponding to the first and third UAVs and calculate a relative position of each of the first UAV and the third UAV within three-dimensional space (a second estimate of the first UAV position and a second estimate of the third UAV position). The two estimates of the position of each UAV can then be combined (e.g., averaged) to improve the accuracy of the estimates (e.g., the first and second estimates of the first UAV can be combined via a weighted or unweighted average, and similarly for the first and second estimates of the second UAV and of the third UAV). It will be understood that image data from each unique pair of UAVs can be used to refine the estimate of its position within three-dimensional space.

Furthermore, the absolute and/or relative positions/orientations/attitudes of the UAVs and/or their cameras can be selected to optimize some aspect of the estimates (e.g., speed of estimate, accuracy in a selected direction (e.g., azimuth, elevation, horizontal, vertical, etc.)). For example, the UAVs may be configured (e.g., programmed) to execute a particular pattern of movements (e.g., from particular coordinated relative altitudes, particular coordinated relative distances from each other, etc.) to gather images from particular relative locations.

Techniques such as neural radiance field (NeRF) techniques can also, or alternatively, be used for image synthesis. For example, deep learning techniques, particularly neural networks, can be used to model the radiance field of a scene. Specifically, a three-dimensional (3D) scene can be reconstructed by estimating the 3D structure and appearance of objects in the scene (e.g., by shooting rays from virtual camera positions and querying the scene's underlying 3D structure and appearance at each ray sample). Using deep neural networks (e.g., multi-layer perceptrons (MLPs)), the volumetric scene can be represented as a neural radiance field. The neural network can take the 3D coordinates and camera viewpoints as input and predict the radiance (e.g., color and brightness) of the scene along each ray. After the radiance field has been constructed using the neural network, volume rendering can be performed to synthesize images from different camera viewpoints (e.g., by integrating the radiance along the rays from the virtual camera positions to create the final images). Although the discussion above assumes the use of image data, it is to be appreciated that other types of data (e.g., from sensors) may be used alternatively or in addition. For example, data from thermal sensors, a sonar system, an electromagnetic source (e.g., emitted by a radio tower), an x-ray sensor, or a radiation detector could be used in addition or instead.

Moreover, different UAVs may be equipped with different types of sensors that provide data that can be fused. For example, if a UAS includes four UAVs, two of them (e.g., a first UAV and a second UAV) can be equipped with optical cameras and two of them (e.g., a third UAV and a fourth UAV) can be equipped with thermal cameras. Optical image data from the optical cameras can be used to calculate a parallax angle of each of corresponding points of the two optical images represented by the optical image data and calculate a relative position of each of the first UAV and the second UAV within three-dimensional space. Additionally, or alternatively, optical image data from the optical camera of the first UAV can be used along with thermal image data from the thermal camera of the third UAV to calculate a parallax angle of each of corresponding points of the two images represented by the optical image data (from the first UAV) and thermal image data (from the third UAV) and calculate a relative position of each of the first UAV and the third UAV within three-dimensional space.

Accordingly, these multi-UAV techniques can be used to determine UAV locations in three-dimensional space with a higher degree of accuracy than with a single UAV. These techniques can be used generally, but they are particularly beneficial for navigation in GPS-denied environments or in other situations in which it is desirable or necessary to use landmarks and/or other correction for inertial navigation.

As stated previously, the disclosed techniques may be particularly beneficial in GPS-denied environments. The disclosed techniques can also be particularly beneficial for UAVs that use thermal cameras because thermal cameras generally have lower resolution than optical cameras.

### C. Using Multiple UAVs to Provide Improved Estimates of Target Positions

Techniques similar to those described above in Section B can also be used to improve estimates of the positions of objects in a scene (targets). To improve estimates of target positions by using multiple UAVs, in some embodiments, multiple UAVs and binocular stereoscopic image data are used to determine the position of a target more accurately than could otherwise be determined using a single UAV. For example, a first UAV can collect first image data of a scene that includes a target from its perspective, and a second UAV can collect second image data of the scene that includes the target from its perspective at substantially the same time as the first UAV. A distance computation unit can use the image data from the two perspectives to calculate a parallax angle of each of corresponding points of the two images represented by the image data and calculate a more accurate estimate of the target's location than would be calculated using a single UAV. The accuracy of the estimate can be improved further if the distances between the UAVs are known to sufficient precision (e.g., as described in Section A above).

The distance computation unit can be located in the first UAV, in the second UAV, in a ground station (e.g., a control unit), or in some combination of the first UAV, the second UAV, and the ground station. The first and/or second UAV may include hardware and/or software allowing them to transmit and/or receive the image data they collect.

The estimated target positions determined by the distance computation unit can be combined (e.g., fused) with geometry/trigonometry-based position estimates determined independently by (or using data from) the first UAV and the second UAV. The fusion process reduces the region of uncertainty of (e.g., noise in) the position estimates (e.g., assuming the noise is uncorrelated).

The relative positions and/or orientations of the first UAV and the second UAV can be modified to improve the estimates of target positions. For example, at a first time, the first UAV and the second UAV can be at approximately the same altitude and at a first distance from each other when they capture a first set of image data including the target. At a second time, the first UAV and the second UAV can be at different altitudes and/or at a different distance from each other and/or at different orientations when they capture a second set of image data including the target. The changes in relative position and/or orientation provide changing stereoscopic estimates that can reduce the noise in the position estimates (assuming the noise is uncorrelated).

The accuracy of the estimates of the target positions can be improved further by using image data from more than two UAVs (e.g., also using a third UAV, or a third and fourth UAV, etc.). This additional image data can be used to reduce the noise in the position estimates. For example, if a UAS includes a first UAV, a second UAV, and a third UAV, and each of the first, second, and third UAVs is equipped with an optical camera, the first UAV may capture first optical image data at a first time, the second UAV may capture second optical image data at the first time, and the third UAV may capture third optical image data and the first time. The first, second, and third optical image data can then be used to calculate respective parallax angles corresponding to the first, second, and third UA Vs to calculate (estimate) a position of a target. By using multiple image data, the accuracy of the estimate of the target's location can be improved. In addition, using multiple image data can reduce the amount of time it takes to achieve an estimate having a specified accuracy set point.

Techniques such as neural radiance field (NeRF) techniques, described above, can also, or alternatively, be used.

Furthermore, the absolute and/or relative positions/orientations/attitudes of the UAVs and/or their cameras can be selected to optimize some aspect of the estimates (e.g., speed of estimate, accuracy in a selected direction (e.g., azimuth, elevation, horizontal, vertical, etc.)). For example, the UAVs may be configured (e.g., programmed) to execute a particular pattern of movements (e.g., from particular coordinated relative altitudes, particular coordinated relative distances from each other, etc.) to gather images from particular relative locations.

Although the discussion above assumes the use of image data, it is to be appreciated that other types of data (e.g., from sensors) may be used alternatively or in addition. For example, and as described above in Section B, data from thermal sensors, a sonar system, an electromagnetic source (e.g., emitted by a radio tower), an x-ray sensor, or a radiation detector could be used in addition or instead.

Moreover, different UAVs may be equipped with different types of sensors that provide data that can be fused. For example, if a UAS includes four UAVs, two of them (e.g., a first UAV and a second UAV) can be equipped with optical cameras and two of them (e.g., a third UAV and a fourth UAV) can be equipped with thermal cameras. Optical image data from the optical cameras can be used to calculate a parallax angle of each of corresponding points of the two optical images represented by the optical image data and calculate a first estimate of a target's location. Additionally, or alternatively, optical image data from the optical camera of the first UAV can be used along with thermal image data from the thermal camera of the third UAV to calculate a parallax angle of each of corresponding points of the two images represented by the optical image data (from the first UAV) and thermal image data (from the third UAV) and calculate a second estimate of the target's location.

Accordingly, these multi-UAV techniques can be used to estimate target locations with a higher degree of accuracy than with a single UAV. As a result, a more accurate target position estimates can be obtained more quickly and/or from a further distance away. Applications that can benefit from the improved accuracy of target position estimates include artillery targeting and detecting the speeds of objects on the ground (e.g., cars on a road).

As stated previously, the disclosed techniques may be particularly beneficial in GPS-denied environments. The disclosed techniques can be particularly beneficial for UAVs that use thermal cameras because thermal cameras generally have lower resolution than optical cameras.

### D. Collaborative Inertial Navigation to Reduce Uncertainty

As explained above, in GPS-denied environments, the UAVs of a UAS typically rely only on dead reckoning using data provided by an INS. Each of the sensors of an INS is subject to errors that together form, in three-dimensional space, a volume of spatial uncertainty (the spatial uncertainty cloud) where the UAV might be. The size and shape of the spatial uncertainty cloud changes over time, generally growing larger because linear accelerations and velocities are integrated without the measurement corrections that would otherwise be provided by position fixing sensor(s) of a position fixing system.

The rate of change of the size of the spatial uncertainty cloud generally increases more rapidly when a UAV accelerates. For example, if a UAS includes a first UAV and a second UAV, and both UAVs speed up (accelerate) and/or change direction at the same time, the size of the spatial uncertainty cloud for each of the first and second UAVs will generally grow.

Accordingly, in accordance with some of the embodiments described herein, two or more airborne UAVs modify their speeds and headings in a coordinated manner to reduce the accumulation of errors due to INS inaccuracies. In some embodiments, a UAS 100 comprises a UAV 105A and a UAV 105B.

The UAV 105A can have a first INS, and the UAV 105B can have a second INS. For purposes of explanation, it is assumed that the UAVs 105 of the UAS 100 are flying in formation (e.g., all of them are flying to the same destination), and it is desirable for the UAVs 105 to change speed and/or direction in a coordinated manner so that the sizes of their respective spatial uncertainty clouds increase less rapidly. Preferably, the UAS 100 knows the distance between the UAV 105A and the UAV 105B.

In some embodiments, a virtual center point of the set of UAVs 105 flying in formation is selected, and data from multiple UAVs 105 is used to reduce uncorrelated errors. For example, assuming the UAVs 105 know (or can estimate to sufficient accuracy) how far apart they are from each other, they can communicate their INS measurements to each other or to a ground station to reduce uncorrelated errors in their INS measurements around a virtual center point. In some embodiments, the UAVs 105 use a secure communication channel to communicate with each other and/or with a ground station to reduce the probability of successful jamming by a third party. For example, the UAVs 105 can use spread spectrum (e.g., direct sequence and/or frequency hopping) and/or multicarrier communication (e.g., coded orthogonal frequency division multiplexing (COFDM)) to reduce the likelihood of jamming.

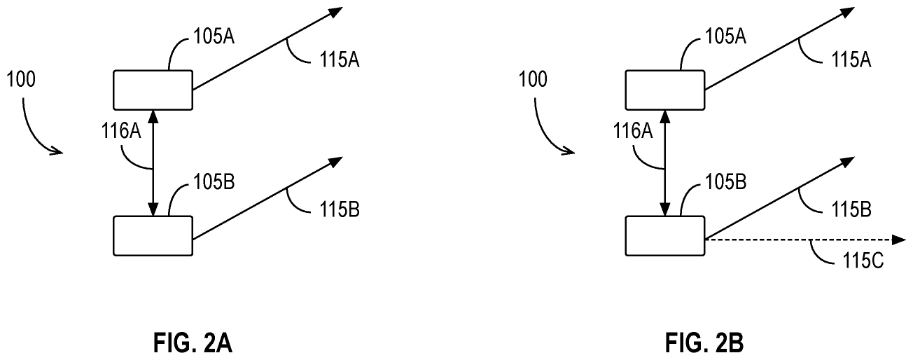

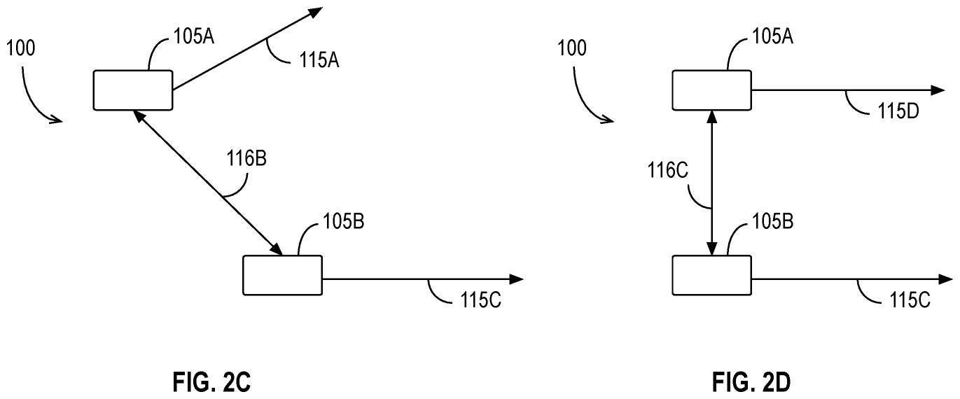

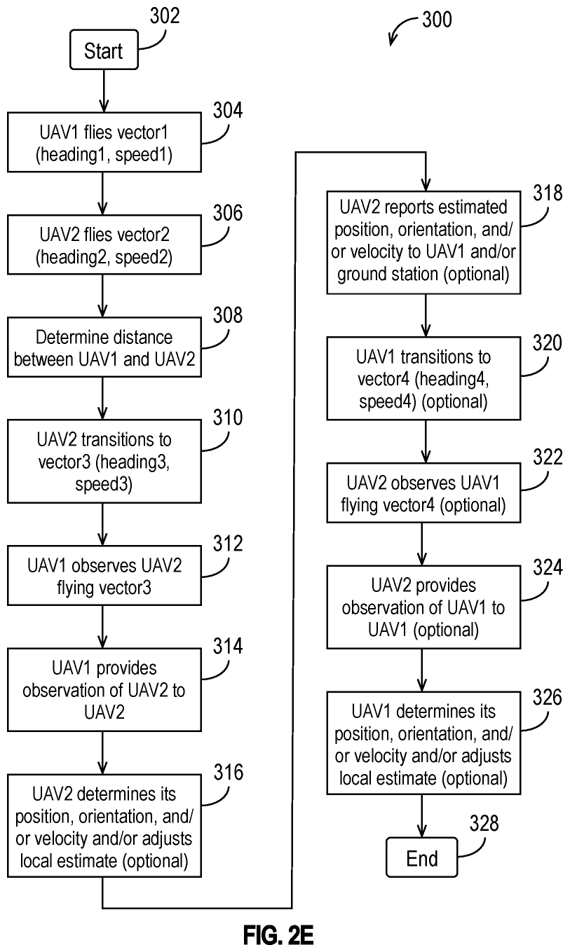

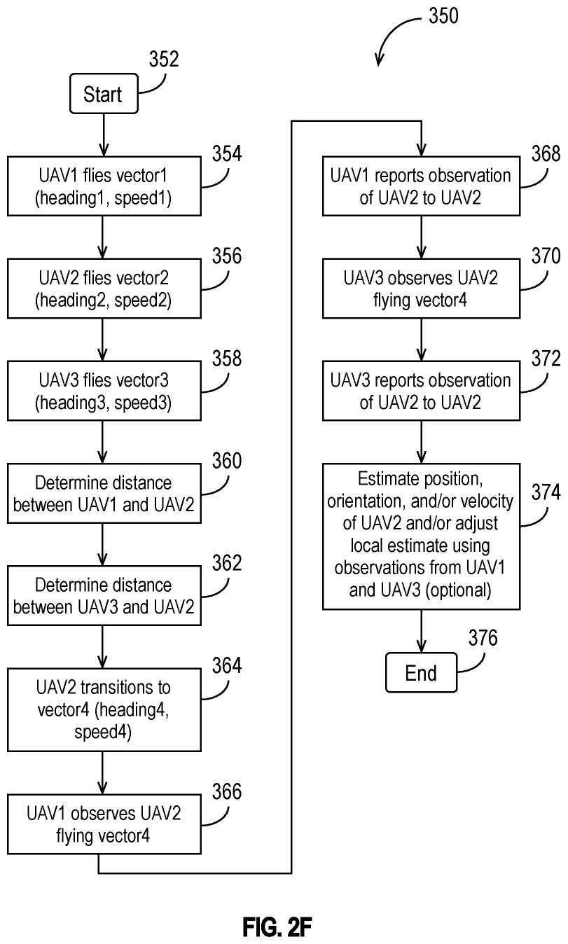

To reduce the growth of the spatial uncertainty clouds when the UAVs 105 flying in formation change their speeds and/or directions, they can make changes one at a time or sequentially. For example, FIG. 2A illustrates a UAS 100 that includes a plurality of UA Vs 105. FIG. 2A illustrates the UAV 105A and the UAV 105B, but it is to be understood that the UAS 100 can include more than two UAVs 105. As shown, the two UAVs 105 are separated by a distance 116A. The distance 116A can be determined in any suitable way (e.g., as explained above in Section A). The UAV 105A is flying a vector 115A (e.g., heading and speed), and the UAV 105B is flying a vector 115B (e.g., heading and speed). The vector 115A and the vector 115B are substantially the same in the example of FIG. 2A.

FIG. 2B illustrates the UAS 100 just before the UAV 105B begins to transition from flying the vector 115B to flying a new vector 115C. The UAV 105A remains flying the vector 115A (its present heading and speed) while the UAV 105B begins to make changes (e.g., turning and/or acceleration/deceleration) that will allow it to fly the new vector 115C. Because the UAV 105A does not change its speed or direction (i.e., it continues to fly the vector 115A), its spatial uncertainty cloud remains approximately the same while the UAV 105B changes heading and/or speed. If the UAV 105B were responsible for determining its position following the change to the new vector 115C, its spatial uncertainty cloud would grow. Instead, in accordance with some embodiments disclosed herein, the UAV 105A can monitor the change in position of the UAV 105B due to the change from the vector 115B to the new vector 115C.

FIG. 2C illustrates the UAS 100 after the UAV 105B has completed its changes (e.g., turns and/or acceleration/deceleration) and is flying the new vector 115C. Because the UAV 105A remained flying its vector 115A, whereas the UAV 105B executed a change from the vector 115B to the new vector 115C, the distance between the UAV 105A and the UAV 105B has changed and is now the distance 116B. With both the UAV 105A and the UAV 105B flying stable vectors, the UAV 105A can report to the UAV 105B (or to a ground station) what it is observing about the position, orientation, velocity, and/or course of the UAV 105B following the change in heading and/or speed (to the new vector 115C). This estimate will generally be more accurate than the estimated position, orientation, velocity, etc. derived from the IMS of the UAV 105B if the distance 116B is known or can be estimated sufficiently accurately. The UAV 105B can then adjust a local estimate of its position, orientation, and/or velocity using the information provided by the UAV 105A. For example, the local estimate can be provided by or derived from data from the onboard INS, and the UAV 105B can make an adjustment to that estimate or to a measurement provided by the INS to improve the accuracy of the local estimate. Alternatively, or in addition, the UAV 105B can deduce the change in its position, orientation, and/or velocity by using the UAV 105A as a reference and knowledge of the time of the maneuver, the previous vector 115B, and the change in distance between the UAV 105A and the UAV 105B (e.g., from distance 116A to distance 116B).

Once the UAV 105B has completed its heading and/or speed change, and its position, orientation, and/or velocity have been estimated/adjusted using information from (or about) the UAV 105A, the UAV 105A can change its heading to the new heading and/or its speed to a new speed while the UAV 105B monitors its change. FIG. 2D illustrates the UAS 100 after the UAV 105A has executed a change to the vector 115D, which is substantially the same as the vector 115C. Because the UAV 105B remained flying its vector 115C, whereas the UAV 105A executed a change from the vector 115A to the new vector 115D, the distance between the UAV 105A and the UAV 105B has changed and is now the distance 116C. With both the UAV 105A and the UAV 105B flying stable vectors, the UAV 105B can report to the UAV 105A (or to a ground station) what it is observing about the position, orientation, velocity, and/or course of the UAV 105A following the change in heading and/or speed (to the new vector 115D). The UAV 105A can then adjust a local estimate of its position, orientation, and/or velocity using the information provided by the UAV 105B. For example, the local estimate can be provided by or derived from data from the onboard INS, and the UAV 105A can make an adjustment to that estimate or to a measurement provided by the INS to improve the accuracy of the local estimate. Alternatively, or in addition, the UAV 105A can deduce the change in its position, orientation, and/or velocity by using the UAV 105B as a reference and knowledge of the time of the maneuver, the previous vector 115, and the change in distance between the UAV 105B and the UAV 105A (e.g., from distance 116B to distance 116C).

If the UAS 100 includes more than two UAVs 105, their headings and/or speeds can be modified one at a time (e.g., as described above in the example of FIGS. 2A-2D), and each of the UAVs 105 that is not undergoing a change can observe the UAV 105 that is undergoing a change. Combining (e.g., averaging) estimates of the new position, orientation, and/or velocity of the UAV 105 that underwent a change corresponding to each of the UAVs 105 not undergoing a change reduces uncertainty in the estimated position, orientation, and/or velocity.

It is to be understood that more than one of the UAVs 105 can change its heading and/or speed at the same time. In some embodiments, each of the UAVs 105 that is changing its heading and/or speed is observed by at least one other UAV 105 that is remaining on its current heading and at its current speed. The UAVs 105 can thus change their headings and speeds in a coordinated way while reducing accumulation errors (e.g., drift).

FIG. 2E is a flow diagram illustrating a method 300 that can be performed by a UAS 100 in accordance with some embodiments. At block 302, the method 300 begins. At block 304, a first UAV (e.g., the UAV 105A), denoted in FIG. 2E as “UAV1,” flies a first vector (“vector1”) that includes a first heading and a first speed, denoted, respectively, as “heading1” and “speed1” in FIG. 2E. At block 306, a second UAV (e.g., the UAV 105B), denoted in FIG. 2E as “UAV2,” flies a second vector (“vector2”) that includes a second heading and a second speed, denoted, respectively, as “heading2” and “speed2” in FIG. 2E. In some embodiments, the first vector and the second vector are substantially identical. For example, UAV1 and UAV2 may be flying in formation.

At block 308, the distance between UAV1 and UAV2 is determined. The distance can be determined in any suitable way (e.g., using any of the techniques described above). For example, the distance can be estimated or measured. In some embodiments, the distance is estimated by UAV1 detecting a known physical characteristic of UAV2, as described above. For example, UAV1 can detect a known shape, alphanumeric character (e.g., a word or number), logo, pattern, code (e.g., a QR code or bar code), color, reflector, etc. on the body of UAV2. In some embodiments, UAV1 and UAV2 communicate with each other to determine the distance between them (e.g., they send information to and/or request information from each other). UAV1 can determine the distance, or UAV2 can determine the distance, or both UAV1 and UAV2 can determine the distance independently, or UAV1 and UAV2 can jointly determine the distance.

At block 310, UAV2 transitions from flying the second vector to flying a third vector (“vector3”), which includes a third heading (“heading3”) and a third speed (“speed3”). At block 312, which takes place after block 310, UAV1 observes UAV2 flying the third vector. UAV1 can observe, for example, the location (absolute or relative), position (e.g., absolute position), relative position (e.g., from UAV1, from a landmark, etc.), orientation, course, or heading of UAV2. At block 314, UAV1 provides to UAV2 its observation of UAV2 flying the third vector. For example, UAV1 can send its report as a message or signal that contains data representing what it observed (e.g., the location (absolute or relative), position (e.g., absolute position), relative position (e.g., from UAV1, from a landmark, etc.), course, or heading of UAV2). UAV1 can provide its observation directly to UAV2, or it could use a relay (e.g., a ground station 200, another UAV 105, etc.).

Optionally, at block 316, UAV2 determines (e.g., estimates) its own position, orientation, and/or velocity and/or it adjusts a local estimate of its position, orientation, and/or velocity following the transition to the third vector. For example, UAV2 may include an INS that provides local estimates of its position, orientation, and/or velocity (e.g., based on measurements as explained above). UAV2 can use the observation from UAV1 to adjust a measurement or value provided by its on-board INS. In determining or estimating (or adjusting an estimate of) its position, orientation, and/or velocity, UAV2 can take into consideration (account for) any relevant information. For example, it can take into account the observation from UAV1. In addition or alternatively, it can take into account any or all of: its distance from UAV1 (before and/or after the transition), its relative position with respect to UAV1 (before and/or after the transition), its relative position with respect to a landmark (before and/or after the transition), the time at which it made the transition to the third vector, the amount of time that has elapsed since the transition to the third vector, the second vector, and/or the third vector. For example, UAV2 can determine its distance from UAV1 after the transition to the third vector and estimate its position using at least the current distance from UAV1 and the third vector (e.g., its current heading and speed).

If block 316 is executed, then optionally at block 318, UAV2 can report its determined (e.g., estimated) position to UAV1 and/or a ground station 200 (e.g., by sending a message or signal containing information). Block 318 can be skipped.

Optionally, at block 320, UAV1 transitions to a fourth vector (“vector4”), which includes a fourth heading (“heading4”) and a fourth speed (“speed4”). In some embodiments, the fourth vector is substantially identical to the third vector so that, after UAV1 transitions to the fourth vector, UAV1 and UAV2 are flying substantially the same heading at substantially the same speed. If block 320 is executed, then optionally at block 322, UAV2 can observe UAV1 flying the fourth vector. UAV2 can observe, for example, the location (absolute or relative), position (e.g., absolute position), relative position (e.g., from UAV2, from a landmark, etc.), orientation, course, or heading of UAV1. If block 320 and block 322 are executed, then optionally at block 324, UAV2 can provide to UAV1 its observation of UAV1 flying the fourth vector. For example, UAV2 can send its report as a message or signal that contains data representing what it observed (e.g., the location (absolute or relative), position (e.g., absolute position), relative position (e.g., from UAV2, from a landmark, etc.), orientation, course, or heading of UAV1). UAV2 can provide its observation directly to UAV1, or it could use a relay (e.g., a ground station 200, another UAV 105, etc.).

If block 320, block 322, and block 324 are executed, then optionally at block 326, UAV1 determines (e.g., estimates) its own position, orientation, and/or velocity and/or it adjusts a local estimate of its position, orientation, and/or velocity following the transition to the fourth vector. For example, UAV1 may include an INS that provides local estimates of its position, orientation, and/or velocity (e.g., based on measurements as explained above). UAV1 can use the observation from UAV2 to adjust a measurement or value provided by its on-board INS. In determining or estimating (or adjusting an estimate of) its position, orientation, and/or velocity, UAV1 can take into consideration (account for) any relevant information. For example, it can take into account the observation from UAV2. In addition or alternatively, it can take into account any or all of: the first vector, the second vector, the third vector, the fourth vector, its distance from UAV2 (before and/or after the transition), its relative position with respect to UAV2 (before and/or after the transition), its relative position with respect to a landmark (before and/or after the transition), the time at which it made the transition to the fourth vector, and/or the amount of time that has elapsed since the transition to the fourth vector. For example, UAV1 can determine its distance from UAV2 after the transition to the fourth vector and estimate its position using at least the current distance from UAV2 and the fourth vector (e.g., its current heading and speed).

At block 328, the method 300 ends.

FIG. 2F is a flow diagram of another method 350 that can be performed by a UAS 100 in accordance with some embodiments. At block 352, the method 350 begins. At block 354, a first UAV (“UAV1,” e.g., the UAV 105A) flies a first vector (“vector1”) that includes a first heading (“heading1”) and a first speed (“speed1”). At block 356, a second UAV (“UAV2,” e.g., the UAV 105B) flies a second vector (“vector2”) that includes a second heading (“heading2”) and a second speed (“speed2”). At block 358, a third UAV (“UAV3,” e.g., the UAV 105C) flies a third vector (“vector3”) that includes a third heading (“heading3”) and a third speed (“speed3”). In some embodiments, the first vector, the second vector, and the third vector are substantially identical. For example, UAV1, UAV2, and UAV3 may be flying in formation.

At block 360, the distance between UAV1 and UAV2 is determined. The distance can be determined in any suitable way (e.g., using any of the techniques described above). For example, the distance can be estimated or measured. In some embodiments, the distance is estimated by UAV1 detecting a known physical characteristic of UAV2, as described above. For example, UAV1 can detect a known shape, alphanumeric character (e.g., a word or number), logo, pattern, code (e.g., a QR code or bar code), color, reflector, etc. on the body of UAV2. In some embodiments, UAV1 and UAV2 communicate with each other to determine the distance between them (e.g., they send information to and/or request information from each other). UAV1 can determine the distance, or UAV2 can determine the distance, or both UAV1 and UAV2 can determine the distance independently, or UAV1 and UAV2 can jointly determine the distance.

At block 362, the distance between UAV3 and UAV2 is determined. The distance can be determined in any suitable way (e.g., using any of the techniques described above). For example, the distance can be estimated or measured. In some embodiments, the distance is estimated by UAV3 detecting a known physical characteristic of UAV2, as described above. For example, UAV3 can detect a known shape, alphanumeric character (e.g., a word or number), logo, pattern, code (e.g., a QR code or bar code), color, reflector, etc. on the body of UAV2. In some embodiments, UAV3 and UAV2 communicate with each other to determine the distance between them (e.g., they send information to and/or request information from each other). UAV3 can determine the distance, or UAV2 can determine the distance, or both UAV3 and UAV2 can determine the distance independently, or UAV3 and UAV2 can jointly determine the distance.

At block 364, UAV2 transitions from flying the second vector to flying a fourth vector (“vector4”), which includes a fourth heading (“heading4”) and a fourth speed (“speed4”). At block 366, which takes place after block 364, UAV1 observes UAV2 flying the fourth vector. UAV1 can observe, for example, the location (absolute or relative), position (e.g., absolute position), relative position (e.g., from UAV1, from a landmark, etc.), orientation, course, or heading of UAV2. At block 368, UAV1 provides to UAV2 its observation of UAV2 flying the fourth vector. For example, UAV1 can send its report as a message or signal that contains data representing what it observed (e.g., the location (absolute or relative), position (e.g., absolute position), relative position (e.g., from UAV1, from a landmark, etc.), orientation, course, or heading of UAV2). UAV1 can provide its observation directly to UAV2, or it could use a relay (e.g., a ground station 200, another UAV 105, etc.).

At block 370, which takes place after block 364, but not necessarily after block 366 or block 368, UAV3 observes UAV2 flying the fourth vector. UAV3 can observe, for example, the location (absolute or relative), position (e.g., absolute position), relative position (e.g., from UAV3, from a landmark, etc.), orientation, course, or heading of UAV2. At block 372, UAV3 provides to UAV2 its observation of UAV2 flying the fourth vector. For example, UAV3 can send its report as a message or signal that contains data representing what it observed (e.g., the location (absolute or relative), position (e.g., absolute position), relative position (e.g., from UAV3, from a landmark, etc.), orientation, course, or heading of UAV2). UAV3 can provide its observation directly to UAV2, or it could use a relay (e.g., a ground station 200, another UAV 105, etc.).

Optionally at block 374, the position, orientation, and/or velocity of UAV2 is estimated, or a local estimate of the position, orientation, and/or velocity is adjusted, using the observations of UAV1 and UAV3. Any suitable technique can be used to estimate the position of UAV2 using the observations of UAV1 and UAV3. For example, UAV2 can combine the observation data provided by UAV1 with the observation data provided by UAV3, such as by averaging. UAV2 can use the observations of UAV1 and UAV2 to adjust locally-sourced measurements or estimates (e.g., from its INS or derived from data provided by its INS) of its position, orientation, and/or velocity.

At block 376, the method 350 ends.

It is to be appreciated that some of the steps of the method 300 and the steps of the method 350 can be performed in parallel and/or in a different order than suggested by FIGS. 2E and 2F, respectively. For example, in FIG. 2E, the optional steps associated with UAV1 transitioning to the fourth vector can precede block 310, block 312, block 314, block 316, and block 318. As another example, in FIG. 2F, the order of block 366, block 368, block 370, and block 372 can be altered. For example, although block 366 is performed before block 368, block 370 could be performed before block 368 or before block 366. Likewise, block 362 can be performed before or at the same time as block 360. In addition or alternatively, block 366 and block 370 can be performed in parallel (e.g., at substantially the same time), as can block 368 and block 372. Variations in the ordering and the possibility to perform certain of the steps in parallel will be apparent to those having ordinary skill in the art in light of the disclosures herein.

It is also to be appreciated that steps of the method 300 and steps of the method 350 can be combined into a single method. For example, some or all of the optional blocks of the method 300 can be added to the method 350. In addition or alternatively, the method 350 can be applied iteratively to track the locations of UAV1 and UAV3 as they transition to new vectors. In addition or alternatively, the method 300 and/or the method 350 can be extended to include additional UAVs of a UAS 100. It will be apparent to those having ordinary skill in the art how to make a variety of combinations of and modifications to the method 300 and the method 350 in light of the disclosures herein.

As stated above, the method 300 can be performed by a UAS 100 that comprises at least a first UAV (UAV1, e.g., the UAV 105A) and a second UAV (UAV2, e.g., the UAV 105B). The method 350 can be performed by a UAS 100 that comprises at least a first UAV (UAV1, e.g., the UAV 105A), a second UAV (UAV2, e.g., the UAV 105B), and a third UAV (UAV3, e.g., the UAV 105C).

The method 300 and/or the method 350 may be particularly helpful in GPS-denied environments. The method 300 and/or the method 350 do not require the use of a ground station 200 but can be used in a UAS 100 that includes one or more ground stations 200.

### E. Using Multiple UAVs to Create a Virtualized UAV With Infinite Battery Life

In some embodiments, multiple UAVs 105 are configured to operate in a coordinated fashion to create a “virtual” UAV with infinite battery life (from the pilot's or user's perspective). The virtual UAV is referred to as being virtual because although it is actually implemented with multiple UAVs 105, the UAS 100 manages various logistics (e.g., during a mission) so that the pilot or user does not have to. As a result, the pilot or user can focus on other things (e.g., data analysis). A virtual UAV can be used for pilot-directed missions, or it can be used to fly a mission without any pilot or user involvement. As an example of a pilot-directed mission, a virtual UAV (or multiple virtual UAVs), managed as described further below, could be used to inspect a region in which there has been a fire, the extent of which is not known when the mission begins. During the mission, a pilot could focus on adjustments to the flight plan based on data (e.g., images or video) provided by the virtual UAV(s). For example, the pilot could adjust the flight plan so that the UAVs 105 only fly over the burn area once the extent of the burn area is known from the UAV-provided data. As an example of a mission with no pilot involvement, a virtual UAV (or multiple virtual UAVs), managed as described further below, could fly the perimeter of a prison on a continual basis and report detected anomalies (e.g., unexpected movement, structural anomalies, etc.) to an operator, who can then assess reported anomalies and determine whether to take any action and, if so, what action to take (e.g., to investigate, to raise an alarm, etc.).

In some embodiments, a UAV 105A begins flying a mission. When a triggering condition occurs (e.g., the battery of the UAV 105A depletes to a threshold level (e.g., insufficient to complete the mission but sufficient to allow the UAV 105A to return to a base for recharging or battery replacement), the UAV 105A identifies an object, target, or landmark, the UAV 105A reaches a specified position, etc.), a UAV 105B flies to the approximate location (altitude, position) of the UAV 105A and replaces it (e.g., providing the same orientation, view, etc.). Once the UAV 105B is in position, the control and/or data feed to/from the UAV 105A can be switched over to the UAV 105B. In addition, a task or function that was being performed by the UAV 105A can be switched to and performed by the UAV 105B. For example, if the UAV 105A was providing a video feed to a ground station 200, the video feed from the UAV 105A can be switched over to the UAV 105B (such that the UAV 105B then provides the video feed to the ground station 200). As another example, the type of data that was being collected by the UAV 105A can be collected by the UAV 105B. As yet another example, the flight plan that was being flown by the UAV 105A can be continued by the UAV 105B. Alternatively, or in addition, the UAV 105B can have a capability that differs from a capability of the UAV 105A, in which case it may be able to provide different functionalities and/or data than were being provided by the UAV 105A.

Once it has been replaced, the UAV 105A can fly to a base (e.g., “home”) for battery replacement or recharging, or it can fly elsewhere if needed. For example, if the UAV 105B replaces the UAV 105A, the UAV 105A could fly to the location of a UAV 105C and replace it.

Accordingly, a virtual UAV with a video feed can provide a “perpetual stare” without interruption when the UAV 105B replaces the UAV 105A, and/or a virtual UAV can be used to complete a long mission or flight pattern without interruption when the UAV 105B replaces the UAV 105A. Likewise, when its battery depletes, the UAV 105B can be replaced by another UAV 105 (e.g., the UAV 105C or the UAV 105A, if its battery has been sufficiently recharged by then). Because the location of the UAV 105 in use is always known to some level of precision (e.g., possibly using one or more of the techniques described above, such as in Section B), replacement UAVs 105 can fly to that location and replace depleted-battery UAVs 105 without any action by the user/pilot. As a result, the replacement of UAVs 105 can be autonomous, thereby making it transparent and improving the pilot experience. The pilot can thus focus on flying a single UAV and not worry about battery life. The UAS 100 handles the replacement of UAVs 105 when their batteries deplete.

It will be appreciated that to perform an action or carry out a task autonomously is to perform the action or carry out the task without external control or influence. An entity or system that operates autonomously makes decisions and takes actions based on its own internal processes or programming, without requiring constant human intervention or guidance. Thus, as used herein, the terms “autonomous” and “autonomously” refer to the ability of an entity (e.g., a UAV 105, a recharging station 250, a ground station 200, etc.) or system (e.g., the UAS 100) to operate independently without human involvement. In some embodiments, autonomous actions taken by the UAS 100 or by its components (either individually or in cooperation) are driven by pre-defined rules, algorithms, and/or artificial intelligence (AI) capabilities used by the UAS 100 and/or individual components of the UAS 100 to analyze information, assess situations, and make decisions. As described further below, the UAS 100 and its components (e.g., the UAVs 105, the recharging stations 250, the ground station 200, etc.) have a level of self-sufficiency and self-governance, allowing the UAS 100 to adapt to changing circumstances and perform tasks (e.g., managing the replacement of UAVs 105 and/or the use of recharging stations 250) without relying on direct or real-time input or instructions from humans (e.g., a pilot, a user, etc.). In some embodiments, discussed further below, missions can be performed by the UAS 100 without consistent or continuous human involvement. Any of the UAVs 105, the recharging stations 250, and/or the ground station 200 can include, among other things, a processor configured to execute machine-executable instructions for autonomously coordinating replacement of UAVs 105, as well as memory storing the machine-executable instructions.

In some embodiments, autonomous aspects of the UAS 100 are carried out by or using one or more of: a hardware infrastructure, a software infrastructure, data, algorithms, training, neural networks, inference, decision-making, feedback loops, and/or a user interface.

In some embodiments, the hardware infrastructure of the UAS 100 includes one or more processors and a suitable hardware infrastructure for data storage, processing, and/or networking. The one or more processors may have capabilities that are helpful for implementing AI (e.g., high parallel processing performance), thereby allowing fast performance of arithmetic operations such as machine training. The one or more processors can be, for example, general processing units (GPUs) and/or specialized AI chips. For example, a processor may include a processor solely for AI, and/or it may be manufactured as a part of an existing general processor (e.g., a CPU or an application processor), and/or it may include a graphic processor (e.g., a GPU).

In some embodiments, AI aspects of the UAS 100 are integrated with other software or systems (e.g., data collection sensors/systems, power/battery monitoring and/or management systems, communication systems, data buses, etc.) to enhance their capabilities or provide specific functionalities. Integration can involve application programming interfaces (APIs), libraries, or services that allow communication and interoperability with other systems.

The UAS 100 may use data as input to learn patterns, make predictions, and/or perform tasks. The data can be structured (e.g., databases) or unstructured (e.g., text, images, videos). Some or all of the data used by the UAS 100 can be collected by one or more components of the UAS 100 (e.g., the ground station 200, the UAVs 105, the recharging stations 250). Some of the data can be provided by a user or pilot, or an external database or service, before a mission begins. The data may be stored in centralized or distributed memory. The UAS 100 may process and analyze the data using algorithms and mathematical models. These algorithms and models can include, for example, machine learning algorithms, deep learning models, natural language processing techniques, computer vision algorithms, and others.

Some or all of the components of the UAS 100 may undergo a training phase where they learn from labeled or unlabeled data to improve their performance. In some embodiments, each mission serves as a training phase for subsequent missions. For example, the UAS 100 can use each mission to refine the algorithms it applies to manage replacement and recharging of UAVs 105 during subsequent missions. During training, the UAS 100 (or components thereof) can adjust internal parameters based on the provided or observed data and feedback. In some embodiments, the UAS 100 includes neural networks comprising interconnected layers of artificial neurons that process and learn from data.

In some embodiments, once a threshold amount of training has been performed, the UAS 100 can perform inference. For example, the UAS 100 can apply the learned knowledge to make predictions (e.g., as to the flight time of UAVs 105 under current weather conditions, the path of an object being followed, etc.) or generate outputs (e.g., decisions as to which specific UAVs 105 will replace other UAVs 105, and when they will replace them, decisions as to which recharging stations 250 will be used by which UAVs 105, etc.) based on new input data. This inference process can allow the UAS 100 to intelligently manage the UAVs 105 and/or recharging stations 250 without pilot/user involvement. In some embodiments, the UAS 100 uses pre-defined rules, logic, or probabilistic models to make decisions (e.g., regarding when and how to replace UAVs 105, usage of the recharging stations 250, etc.) based on input data or learned patterns. In some embodiments, the UAS 100 includes a feedback loop that allows the UAS 100 to continuously learn and improve over time. The feedback can be provided by any suitable source (e.g., the pilot or user, components of the UAS 100, etc.).

In some embodiments, the ground station 200 includes a software user interface (UI) or application layer through which the pilot or user can interact with the UAS 100. The UI can be in any suitable form (e.g., a web application, a computer program, a mobile application, etc.).

Although the examples provided herein describe and illustrate a single ground station 200, it is to be appreciated that the UAS 100 can include a plurality of ground stations 200 that cooperate to manage the UAVs 105. For example, multiple ground stations 200 may be able to communicate with each other (e.g., via a network) to hand-off management and/or replacement of UAVs 105. In embodiments that include multiple ground stations 200, each ground station 200 can have an associated volume of space (a “cell”) and can be responsible for managing and/or replacing UAVs 105 within that volume of space. The ground stations 200 in a multi-ground station 200 UAS 100 can operate according to rules and protocols that govern hand-offs of UAVs 105 flying from one cell into another.

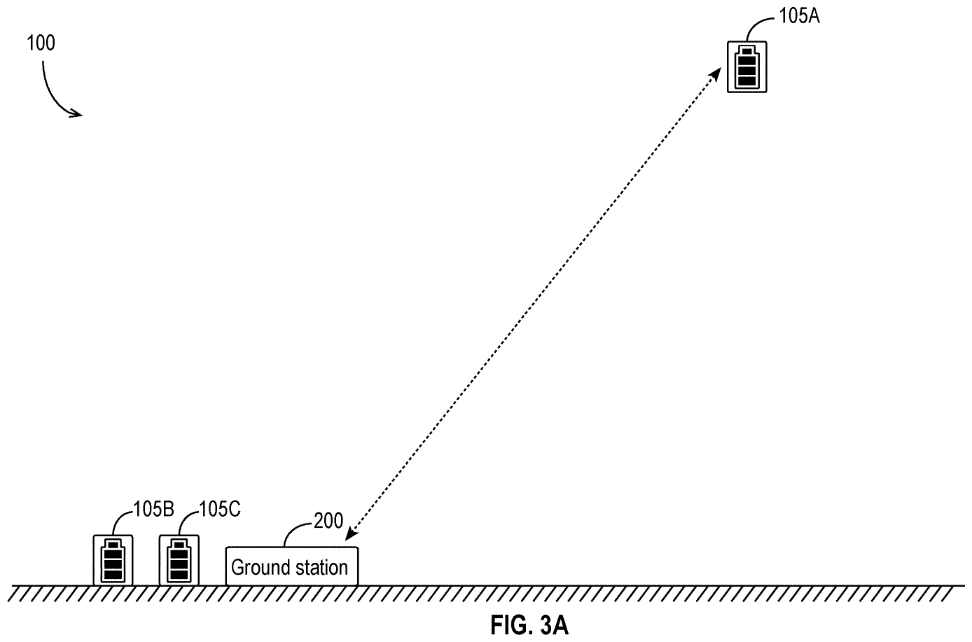

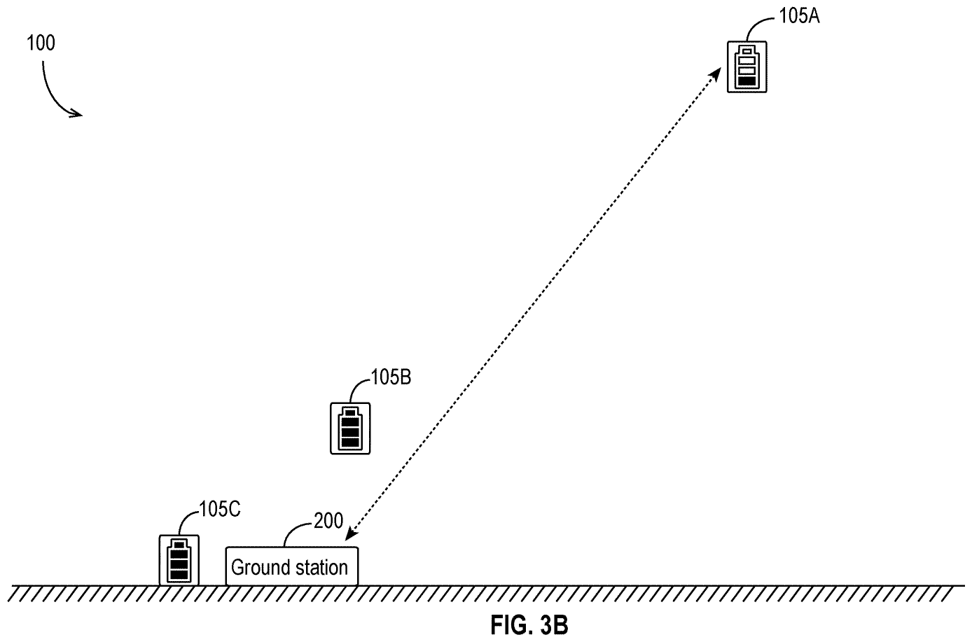

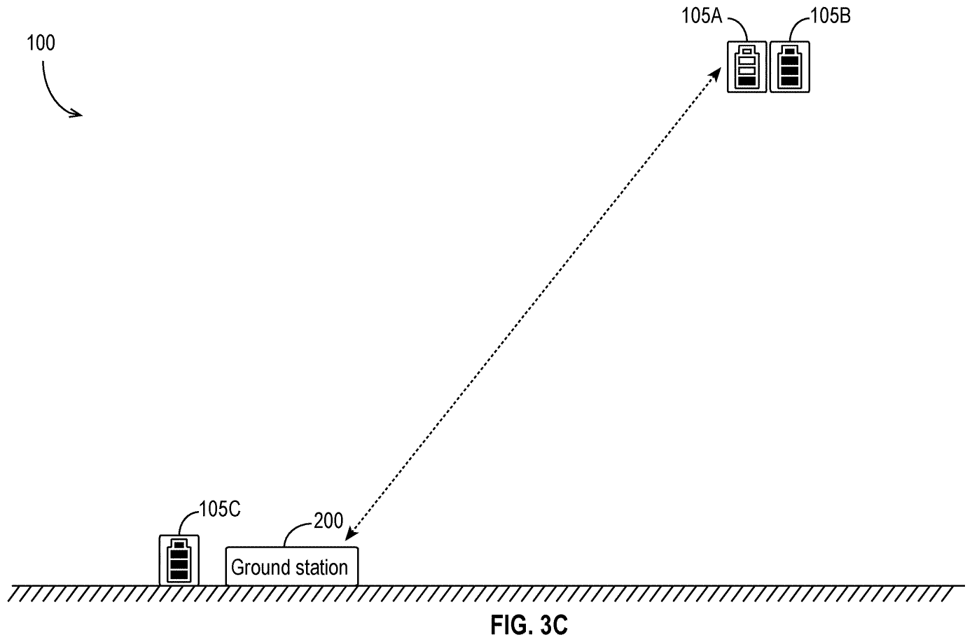

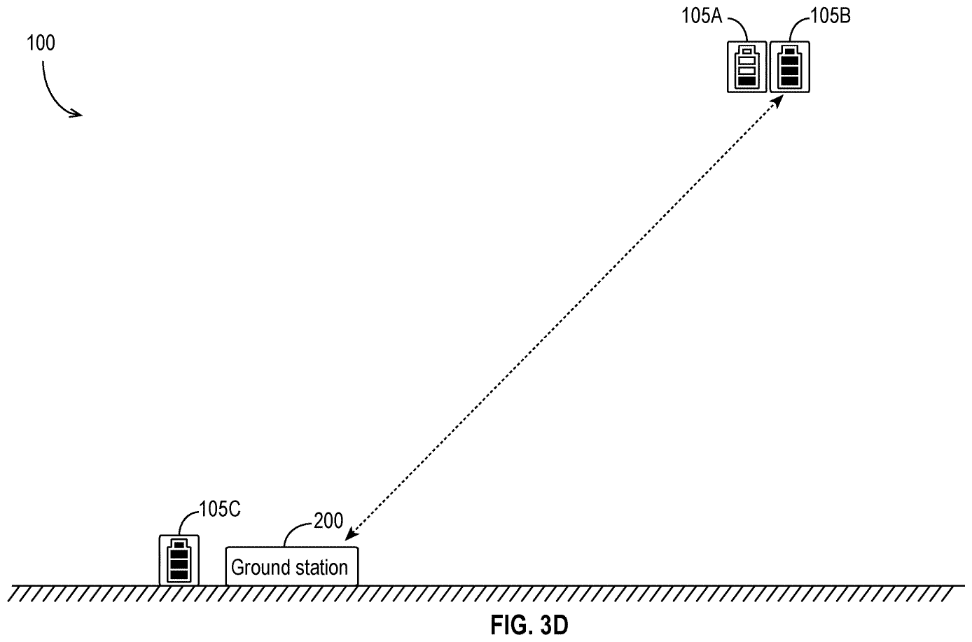

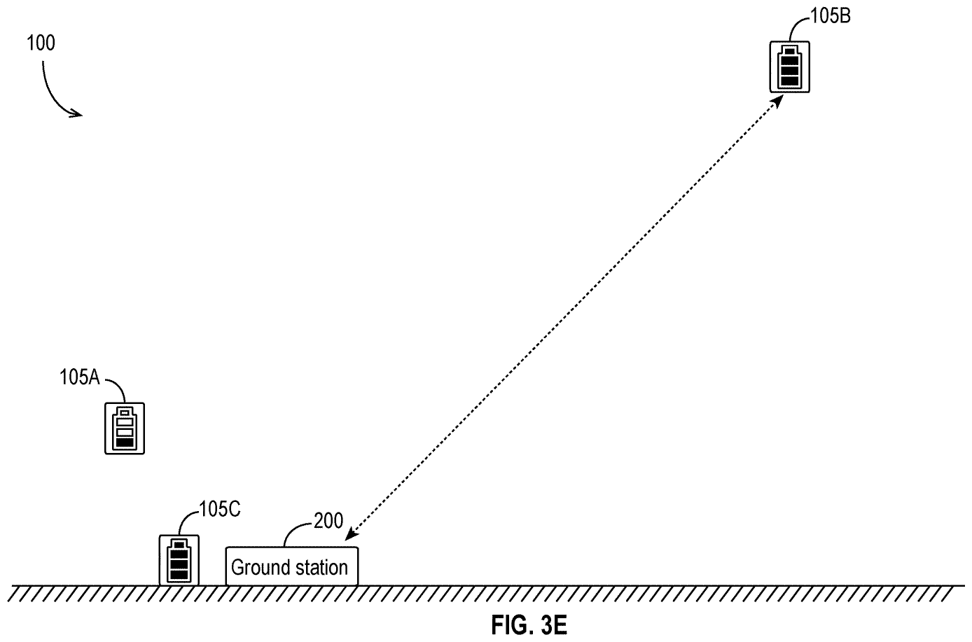

FIGS. 3A through 3E illustrate the use of multiple UAVs 105 that together act as a single, virtualized UAV 105 in accordance with some embodiments. The explanation below assumes that the virtualized UAV 105 is providing a perpetual stare and that the condition that triggers replacement is battery level, but it is to be appreciated that the discussion is applicable to any mission carried out by multiple UAVs 105 (e.g., flying a flight plan, etc.), and other triggering conditions can be used (e.g., elapsed time, identification of a target, etc.). FIG. 3A illustrates an example of a UAS 100 that includes a ground station 200, a UAV 105A, a UAV 105B, and a UAV 105C. The battery level of each of the UAVs 105 is shown by a battery indicator. Initially, the UAV 105A is airborne and has a full battery. The UAV 105A is in communication with the ground station 200 (e.g., possibly using a secure channel that is resilient to jamming), and the UAV 105B and UAV 105C are on the ground in reserve. The UAV 105B and the UAV 105C can be physically situated in any convenient location. For example, they may be situated near the ground station 200. As another example, the UAV 105B and/or the UAV 105C can be situated on mobile platforms, as described further below. As another example, the UAV 105B and/or the UAV 105C can be situated in a location that is some distance from, but still within communication distance of, the ground station 200. Alternatively, one or both of the UAV 105B and the UAV 105C can be remote from the ground station 200 and unable to communicate with the ground station 200. As explained above, the UAV 105A, the UAV 105B, and the UAV 105C can use a communication channel that is resilient to jamming to communicate with the ground station 200 and/or each other.

In FIG. 3B, the battery of the UAV 105A has depleted to a threshold level that triggers activation of the UAV 105B so that it can replace the UAV 105A without the pilot's involvement (i.e., the replacement of the UAV 105A by the UAV 105B can be done autonomously by the UAS 100). The activation of the UAV 105B can be triggered by a signal from the UAV 105A (e.g., directly to the UAV 105B or via the ground station 200, which then activates the UAV 105B without the user's involvement, etc.). In some embodiments, the activation of the UAV 105B is based at least in part on information retrieved (e.g., by the ground station 200 or the UAV 105B) from the UAV 105A (e.g., information about a battery or power level, an estimated flight time (e.g., remaining or flown), an observation (e.g., of weather), a target, a landmark, a temperature, etc.). Alternatively, the activation of the UAV 105B can be triggered by an activation signal from the ground station 200 (e.g., based on real-time information about or an estimate of the battery level of the UAV 105A and/or other factors discussed further below). In some embodiments, if the UAV 105B is situated on a recharging station 250, as described further below, the recharging stations 250 can assist in the activation of the UAV 105B.

As an alternative to triggering the replacement of the UAV 105A by the UAV 105B based explicitly on battery level, the activation of the UAV 105B can be triggered after a specified period of time. For example, if it is known that the maximum expected flight time of the UAV 105A is T, the trigger for the UAV 105B to replace the UAV 105A could be after a period of 0.8 T, 0.9 T, or any other value less than T. The value of T can be selected so that the UAV 105A is expected to have enough remaining battery power to fly to a recharging station 250, as described below. Use of a period of time as the trigger to replace the UAV 105A can be desirable in embodiments in which, for example, it is desirable to reduce signal communications (e.g., in a region where eavesdropping or jamming might be of concern). In some embodiments, the specified period of time is adjustable (e.g., based on actual conditions experienced during the mission, such as, for example, rate of battery depletion, charge remaining when the UAV 105A arrives at the recharging station 250, weather, etc.).

Other events or conditions can also or alternatively be used to trigger the replacement of the UAV 105A by the UAV 105B. Any suitable trigger or combination of triggers can be used. Some examples of triggers include: a detected or estimated battery level of the UAV 105A, an elapsed amount of time, an estimated remaining flight time of the UAV 105A, an estimated remaining flight time in the mission, an estimated remaining flight distance in the mission, a predicted position of a target, an observation of the target, or a predicted arrival time of the target. In some embodiments, the decision to replace the UAV 105A by the UAV 105B is based, at least in part, on information about the UAV 105A and/or the UAV 105B, such as, for example, a make, a model, a serial number, a position, a battery level, a hardware configuration, an expected flight time, a software configuration, and/or a communication capability. In some embodiments, the decision to replace the UAV 105A by the UAV 105B is based, at least in part, on information about an object or event detected by the UAV 105A, the UAV 105B, and/or a source external to the UAS 100. The information about the object or event can be, for example, information about an object, a target, and/or a landmark.

In addition, or alternatively, information gathered by the UAS 100 before the beginning of the mission can be used to trigger the replacement of the UAV 105A by the UAV 105B. For example, before the mission, the UAS 100 may gather data from a sensor (e.g., imaging data, thermographic data, meteorological data, etc.), geographic data (e.g., about a terrain, landmark locations, bodies of water, etc.), or information about at least one of: a battery level (e.g., how long the battery allows a UAV 105 to fly, a power level (e.g., used in a prior flight), a flight time (e.g., from a previous mission), an observation (e.g., weather), a temperature, a rate of battery depletion (e.g., under specified flight conditions), an object (e.g., a target's size, speed, shape, etc.), a landmark (e.g., its location, size, shape, etc.), or a route taken by a target (e.g., discovered during a previous mission, etc.).

As shown in FIG. 3B, once activated, the UAV 105B flies toward the UAV 105A. In some embodiments, the UAV 105A and the UAV 105B communicate with each other, either directly or through the ground station 200, to prevent collisions during the replacement maneuver. For example, the UAV 105A and UAV 105B can configure themselves such that their vectors (e.g., power and direction) prevent them from colliding while the UAV 105B replaces the UAV 105A in the loitering area. During the switch, the UAV 105A and the UAV 105B can communicate with each other and/or the ground station 200 to update their thrust vectors to ensure they maintain sufficient separation from each other and from other objects or obstacles that might otherwise cause collisions during the switch operation. The UAV 105A and/or the UAV 105B can use, for example, the techniques described in the sections above. In FIG. 3C, the UAV 105B has arrived at substantially the same hovering location as (e.g., it is in the same loitering area as) the UAV 105A. Accordingly, the UAS 100 has the UAV 105A and the UAV 105B in position to switch the communication (e.g., control feed, video feed, data feed, etc.) between the ground station 200 and the UAV 105A, the battery of which is depleted, to communication between the ground station 200 and the UAV 105B, which has a substantially full battery.

FIG. 3D shows the UAS 100 after communication to/from the ground station 200 has been switched from the UAV 105A to the UAV 105B. The UAV 105A can now fly to a location where it can recharge its battery or have a replacement battery installed. FIG. 3E shows the UAV 105A en route back to the reserve location, where its battery can be recharged or replaced.

As stated above, although FIGS. 3A through 3E illustrate and the discussion above describes a use case in which the working drone is loitering, it is to be appreciated that the same approach can be used for a drone that is not loitering (e.g., it is flying a flight plan or route). For example, if the UAV 105A is flying a route to inspect a building or a field, and its battery level is insufficient for it to complete the route, the procedures described herein can allow the UAV 105B (and/or UAV 105C) to replace the UAV 105A and continue flying the route without the pilot even knowing that multiple UAVs 105 flew the route and collected and/or provided the data.

In some embodiments, a UAS 100 includes a fleet of virtual UAVs. For example, a user/pilot (or multiple users/pilots) could control four virtual UAVs, each of which is carried out by several UAVs 105 (e.g., two or three or four UAVs 105 per virtual UAV). These 8-16 UAVs 105 could all have logistics (e.g., replacement, recharging, etc.) handled by a ground station 200 (where a ground station 200 can refer to, for example, a control center/station, nest, or any other user-accessible platform that interfaces with the UAVs 105) that manages the swapping and power management (e.g., recharging) of the individual UAVs 105 of the UAS 100 to relieve the user/pilot of the responsibility.

The replacement UAVs 105 can be from a centralized location (e.g., as shown in FIGS. 3A through 3E), or they may be distributed along a mission route. Additionally, UAVs 105 that are not flying the mission but are available as replacement UAVs 105 need not be stationary and need not remain in the same position(s) as the mission progresses. For example, they may be located on or in a platform that is moving (e.g., a truck or other vehicle, a boat, a flying object, etc.). In addition, as described further below, in some embodiments the UAVs 105 that are not flying the mission can move (e.g., to situate them in more desirable positions in case they are called into service, to redistribute them among recharging stations 250, etc.).

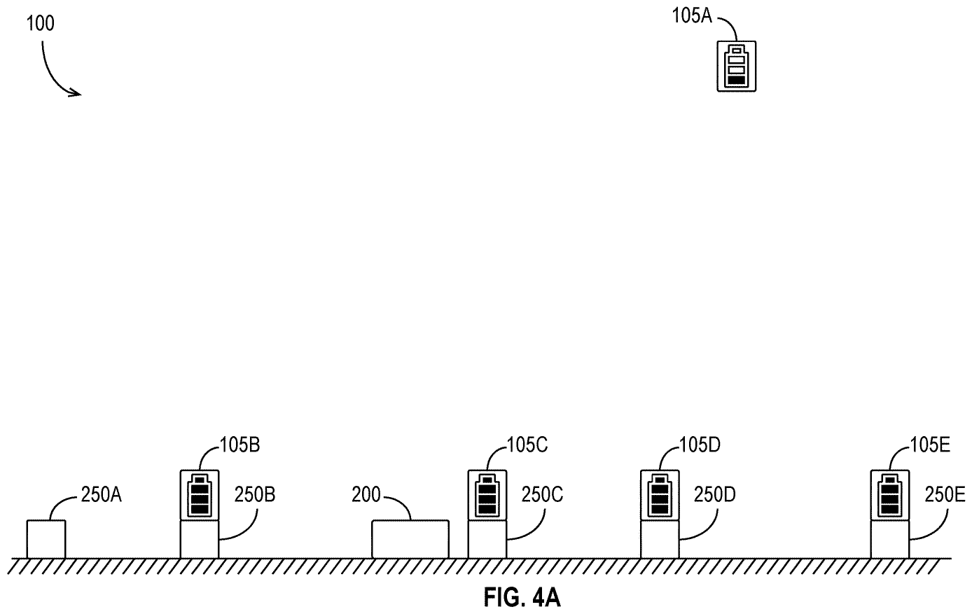

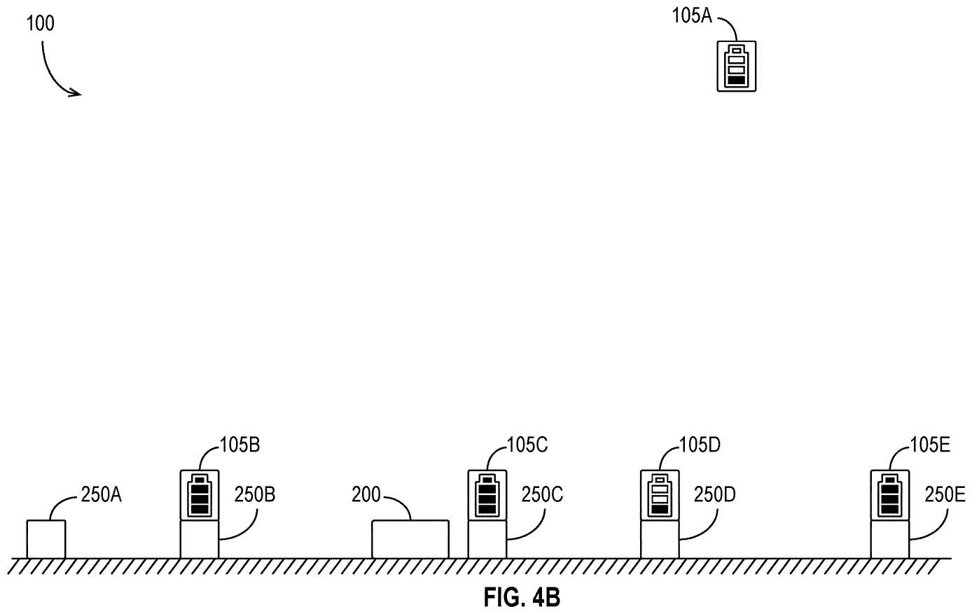

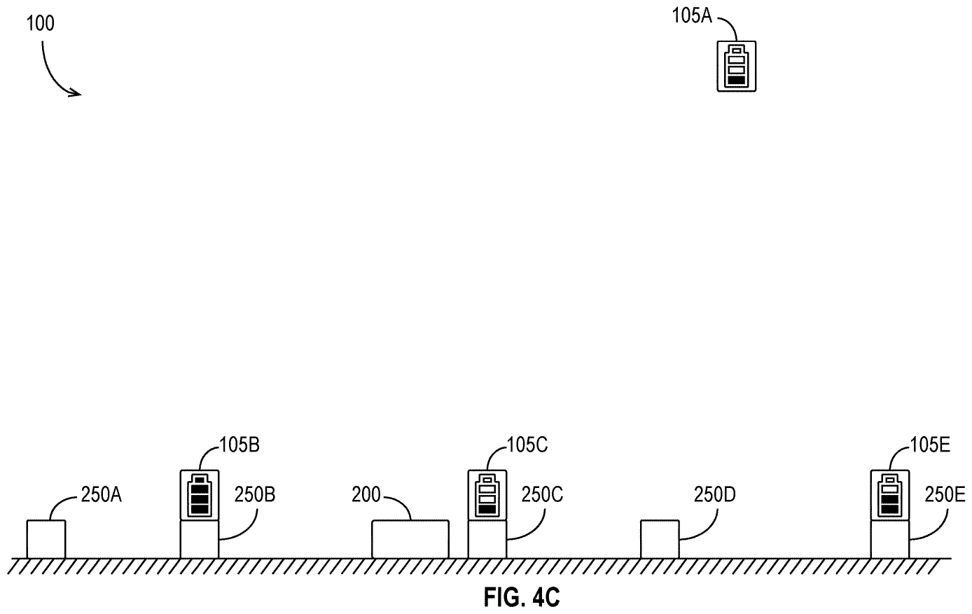

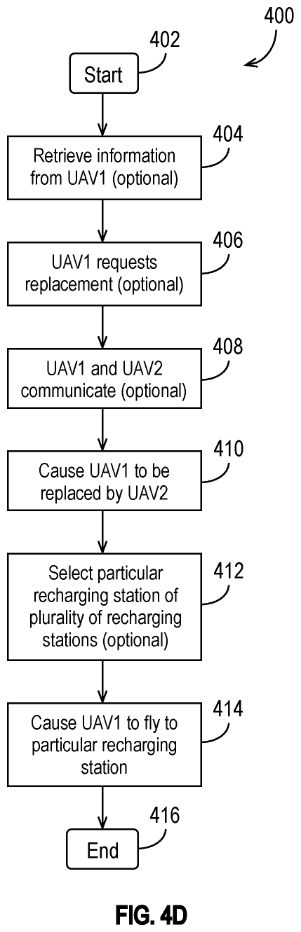

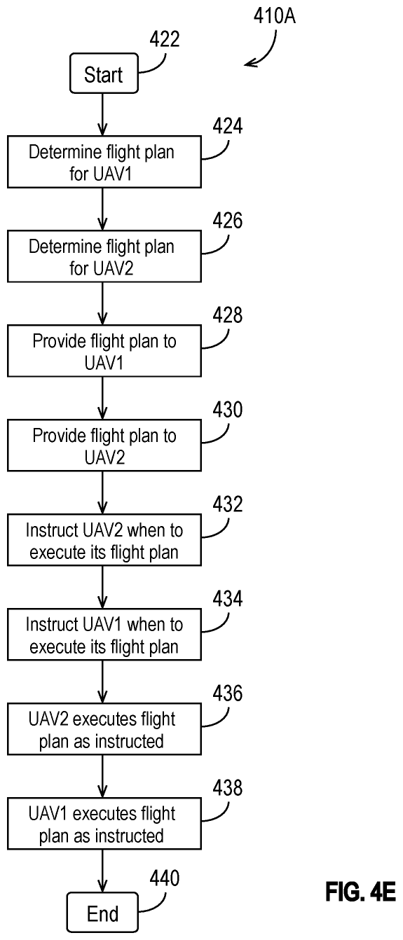

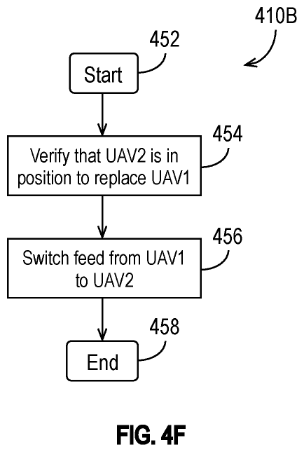

FIG. 4A illustrates a UAS 100 with multiple recharging stations situated in different physical locations in accordance with some embodiments. In the example shown in FIG. 4A, the UAS 100 includes five UAVs 105, namely the UAV 105A, the UAV 105B, the UAV 105C, the UAV 105D, and the UAV 105E, and five recharging stations 250, namely the recharging station 250A, the recharging station 250B, the recharging station 250C, the recharging station 250D, and the recharging station 250E. The locations of the recharging stations 250 can be any suitable locations (e.g., distributed along a mission route or beneath a loitering area). Furthermore, the locations of the recharging stations 250 need not be fixed. In other words, in some embodiments, the locations of the recharging stations 250 can change during a mission. In other words, one or more of the recharging stations 250 can have a variable location. For example, recharging stations 250 can be situated in the bed of a moving truck, on the roof of a moving vehicle, on a boat, on a flying object, or on some other platform that is capable of moving. In such embodiments, the dynamic location(s) of the recharging stations 250 can be incorporated into the decision-making processes described further below (e.g., to decide which of the recharging stations 250 the UAV 105 being replaced will be routed to).

Although FIG. 4A shows one UAV 105 per recharging station 250, it is to be appreciated that each of the recharging stations 250 can accommodate/recharge one or more UAVs 105 at a time. It is also to be appreciated that the UAS 100 can include more or fewer than five of the recharging stations 250, and more or fewer than five of the UAVs 105. It is not a requirement that the UAVs 105 and the recharging stations 250 be in a one-to-one relationship. There can be more or fewer UAVs 105 than recharging stations 250. For example, in a UAS 100 that includes two UAVs 105, there may be only one recharging station 250, which can be shared by the two UAVs 105.

When a UAS 100 includes multiple recharging stations 250 and/or multiple UAVs 105, such as in the example of FIG. 4A and elsewhere herein, the UAS 100 includes software and hardware (e.g., at least one processor configured to execute machine executable instructions in memory) that allows the UAS 100 to manage details of the mission without the pilot's involvement. For example, the UAS 100 can autonomously determine (a) which of the UAVs 105 flies during which time period, (b) when the UAVs 105 are to be recharged, (c) when the UAS 100 includes multiple recharging stations 250, which of the recharging stations 250 are used for which UAVs 105, and (d) any other details associated with the virtualized UAV. In determining how to manage usage of the UAVs 105 and the recharging stations 250, the UAS 100 (or one or more components thereof) can perform an analysis that accounts for current conditions (e.g., weather, UAV battery levels, etc.) and mission goals (e.g., duration of flight, distance of flight, objectives (e.g., type of data being captured), etc.). As explained further below, the decisions, such as, for example, which of the UAVs 105 in the UAS 100 will replace the UAV 105 flying a mission, when that replacement will take place, and/or where the UAV 105 being replaced will fly after being replaced (e.g., which recharging station 250 it will use in the event there are multiple recharging stations 250), can be made by the ground station 200, by the returning UAV 105, by the replacement UAV 105, and/or by any of the other UAVs 105 in the UAS 100. The decisions can be made unilaterally by a single component of the UAS 100 (e.g., by the ground station 200) or jointly by multiple components of the UAS 100 (e.g., by two or more of the ground station 200, the UAV 105 being replaced, the replacement UAV 105, any of the other UAVs 105). In some embodiments, the recharging station(s) 250 includes hardware and/or software and can participate in decision-making. For example, recharging stations 250 can include components that allow them to assist incoming and/or outgoing UAVs 105. For example, the recharging stations 250 can include hardware and/or software to help guide a returning UAV 105. As another example, the recharging stations 250 can include hardware and/or software to communicate with UAVs 105 (e.g., before the arrive, while they charge (e.g., firmware updates, mission information downloads, etc.), or after they depart).

In some embodiments, and as illustrated in FIG. 4A, the UAS 100 includes multiple recharging stations 250 (e.g., distributed across an area or along a mission route), and a particular recharging station 250 is selected for a returning UAV 105 based on one or more factors. In some embodiments, a particular recharging station 250 is selected based at least in part on its distance from the returning UAV 105 when a battery level of the UAV 105 reaches a specified threshold. For example, those recharging stations 250 within a distance X or within an estimated remaining flight time of the returning UAV 105 are candidate recharging stations 250. In some embodiments, a particular recharging station 250 is selected based at least in part on its distance from the returning UAV 105 after a specified period of time. For example, those recharging stations 250 within a distance X or within an estimated remaining flight time of the returning UAV 105 after the specified period of time has elapsed are candidate recharging stations 250. Thus, a particular recharging station 250 can be selected for use by the returning UAV 105 based at least in part on a battery level of the returning UAV, a power level of the returning UAV, an estimated flight time of the returning UAV, an observation, a target, a landmark, a temperature, etc. A particular recharging station 250 can be selected for use by the returning UAV 105 based at least in part on information retrieved (e.g., by a ground station 200) from the returning UAV 105. The information can include, for example, a battery level, a power level, an estimated flight time, an observation, or a temperature.

In some embodiments, a particular recharging station 250 is selected based at least in part on the occupancy of the recharging stations 250. Some or all of the recharging stations 250 can be occupied during a mission. In the example shown in FIG. 4A, the UAV 105A is executing a mission (e.g., loitering, flying a flight plan, etc.), and the UAV 105B, UAV 105C, UAV 105D, and UAV 105E are at recharging stations 250. Specifically, the UAV 105B is at the recharging station 250B, the UAV 105C is at the recharging station 250C, the UAV 105D is at the recharging station 250D, and the UAV 105E is at the recharging station 250E. In the illustrated scenario, the battery of the UAV 105A has partially depleted, and the UAV 105A has insufficient power to complete the mission and needs to be recharged. In FIG. 4A, each of the UAV 105B, UAV 105C, UAV 105D, and UAV 105E is fully charged and, therefore, has a sufficient battery level to replace the UAV 105A and continue the mission. Which of the UAVs 105 that is selected to replace the UAV 105A and/or which of the recharging stations 250 the UAV 105A is routed to for recharging can depend on one or more factors taken into account by the UAS 100 without involvement of the pilot or other human intervention. In the following discussion, it is assumed for ease of explanation that the UAV 105A is the returning UAV 105, and one of the UAV 105B, UAV 105C, UAV 105D, or UAV 105E is selected as the replacement UAV 105. It is also assumed that all of the UAVs 105 have the capabilities to continue the mission (e.g., they are identical or they all have the hardware and/or software needed for the mission), and that they can all recharge at any of the recharging stations 250.

In some embodiments, the UAV 105 that is closest to the UAV 105A and is fully charged (or, as explained further below, has sufficient power to continue the mission for a desired period of time) is selected as the replacement UAV 105. In the example situation shown in FIG. 4A, the recharging station 250 that is closest to the UAV 105A is the recharging station 250D, which is occupied by the UAV 105D. In this case, because the UAV 105D is fully charged and is closest to the location of the UAV 105A, the UAV 105D can be selected to replace the UAV 105A. Because the UAV 105D vacates the recharging station 250D to replace the UAV 105A, the UAV 105A can return to the recharging station 250D to recharge. The UAV 105A and the UAV 105D therefore swap positions.

In some embodiments, one or more current or recent flight conditions (e.g., wind speed, wind direction, wind shear, temperature, etc.) are taken into account to select the replacement UAV 105 and/or the recharging station 250 for the returning UAV 105. For example, in the situation illustrated in FIG. 4A, if the wind is blowing in the direction from left to right on the page, the UAV 105E, which is a further distance from the UAV 105A but is fully charged, might be selected to replace the UAV 105A, even though it would experience a headwind while flying to the position of the UAV 105A. Alternatively, if a strong wind is blowing in the direction from right to left on the page, the UAV 105E might be selected as the replacement UAV 105, and the UAV 105A might fly to the recharging station 250A with a tailwind instead of flying to the recharging station 250E with a headwind. Because the UAS 100 has information about current conditions, it is in a better position than the pilot to decide when to replace the UAV 105A, which of the remaining UAVs 105 to replace it with, and where to route the UAV 105A after it has been replaced. The UAS 100 can make all of these decisions without the involvement of the pilot.

In the situation illustrated in FIG. 4A, all of the UAVs 105 that can be replacement UAVs 105 are fully charged. FIG. 4B shows an example situation in which the charge levels of the candidate replacement UAVs 105 differ. Again it is assumed that all of the UAVs 105 have can recharge at any of the recharging stations 250. In FIG. 4B, the UAV 105D, which is closest to the location of the UAV 105A, is not fully charged. Based on an analysis of the battery level of the UAV 105D, the needs of the mission (e.g., remaining time in flight, distance to be flown, etc.), weather conditions, etc., the UAV 105D could still be suitable to replace the UAV 105A, despite its partially-depleted battery. Alternatively, it may be determined that a different UAV 105 than the UAV 105D will replace the UAV 105A. In the illustrated example, the UAV 105C and the UAV 105E are both relatively close to the location of the UAV 105A, so one of them might be selected based on any suitable factor(s) and/or condition(s) (e.g., their capabilities, weather conditions, mission needs, etc.). For example, if the UAV 105C has the desired capabilities to continue the mission, and the UAV 105A is capable of flying to the recharging station 250C (e.g., the wind is calm or blowing from right to left on the page, etc.), the UAV 105C might be selected as the replacement, whereas the UAV 105E might be selected under different conditions (e.g., the wind blowing from left to right on the page, or the UAV 105C does not have the capability to fly the mission (e.g., if video is being taken and the UAV 105C does not include a suitable camera)).

It is to be appreciated that more complicated replacement scenarios are possible and can be handled by the UAS 100 without pilot involvement. For example, it may be the case that the UAV 105A has enough power to fly only to the recharging station 250D under the current conditions. The recharging station 250D is occupied by the UAV 105D, which is not fully charged. Assume, for the sake of example, that the UAV 105D has insufficient power to continue the mission, but the UAV 105C has the capability and sufficient power to continue the mission. In this case, the UAV 105C can vacate the recharging station 250C and fly toward the UAV 105A to continue the mission, and the UAV 105D can vacate the recharging station 250D and fly to the recharging station 250C, where it can continue charging. The UAV 105A can then hand over responsibility for the mission to the UAV 105C and fly to the recharging station 250D for recharging.

Similarly, it may be the case that particular UAVs 105 in the UAS 100 can only recharge at a subset of the recharging stations 250. This could be the case, for example, if the UAS 100 includes two or more types of UAVs 105 (e.g., UAVs 105 made by different manufacturers, UAVs 105 of different sizes/capabilities, etc.), where each type uses recharging stations 250 that are incompatible with the recharging stations 250 used by the other types. Referring to FIG. 4B, assume for the sake of example that the UAV 105A can only recharge at the recharging station 250A, which is unoccupied, or the recharging station 250E, which is occupied by the UAV 105E. Assume further that the UAV 105A has insufficient power to fly to the vacant recharging station 250A. In this situation, the UAV 105E can vacate the recharging station 250E and either replace the UAV 105A (if the UAV 105E is to continue the mission) or fly to the recharging station 250A (e.g., if another of the UAVs 105 will continue the mission, if the mission is complete, etc.) so that the UAV 105A can return to the recharging station 250E. It is not necessary that the UAV 105A occupy a recharge station vacated by the replacement UAV 105. As this example indicates, the decision as to which of the recharging stations 250 the UAV 105A will fly to can be made independently of the decision as to which of the other UAVs 105 will replace the UAV 105A (if the mission is not yet complete).

FIG. 4C illustrates another example scenario in accordance with some embodiments. As shown in FIG. 4C, the UAV 105A has a depleted battery and needs to be recharged. The UAV 105B is at the recharging station 250B, the UAV 105C is at the recharging station 250C, and the UAV 105E is at the recharging station 250E. The recharging station 250D is unoccupied. With respect to the decision as to where the UAV 105A will go for recharging, in one example, the UAV 105A is compatible with the recharging station 250D. In this case, the UAV 105A can return to the recharging station 250D to recharge without any other of the UAVs 105 moving. In another example, the UAV 105A is incompatible with the recharging station 250D but compatible with the recharging station 250A, which, in FIG. 4C, is unoccupied. In this case, if the UAV 105A has sufficient battery power to fly to the recharging station 250A, then the UAV 105A can fly to the recharging station 250A for recharging without any of the other illustrated UAVs 105 moving. In yet another example, the UAV 105A is incompatible with both the recharging station 250A and the recharging station 250D (or the UAV 105A is compatible with but has insufficient battery power to fly to the recharging station 250A), but it is compatible with, for example, the recharging station 250E, which is occupied by the UAV 105E. In this case, the UAV 105E, which is not fully charged but has more battery life remaining than the UAV 105A, can vacate the recharging station 250E and either replace the UAV 105A (e.g., if it has sufficient battery life to continue the mission, such as if the mission is almost complete, or the UAV 105E will only have to be in use for a short time before itself being replaced) or fly to another unoccupied recharging station 250 it is compatible with so that the UAV 105A can use the recharging station 250E. For example, the UAV 105E could move to the recharging station 250D, the UAV 105A could return to the recharging station 250E, and the UAV 105B could be selected to replace the UAV 105A (assuming it has the necessary capabilities to continue the mission).

When the UAVs 105 in a UAS 100 are not substantially identical with respect to their suitability as replacement UAVs 105 (e.g., their battery levels differ, their capabilities differ, their distances from the UAV 105A differ, etc.), a UAV 105 that meets specified criteria can selected (e.g., as the result of an analysis or optimization procedure) as the replacement UAV 105. The decision as to which of the UAVs 105 will replace the UAV 105A can take into account any data or condition that has an impact on the continuation of the mission. For example, the decision can take into account one or more of (a) distance between the candidate replacement UAV 105 and the UAV 105A (either currently or as of when the replacement will occur), (b) battery level and/or expected flight time of the replacement UAV 105, (c) weather conditions (e.g., wind speed and direction, temperature, humidity, etc.), (d) remaining time and/or distance in the mission, (e) capabilities of the candidate replacement UAV 105 (e.g., sensors, flight capabilities, size, battery depletion rate, etc.), etc. For example, with continued reference to FIG. 4C, in some embodiments, any UAV 105 that meets a specified battery level target and has desired characteristics (e.g., sensors, size, flight time, etc.) is selected as the replacement UAV 105 for the UAV 105A (assuming the mission is ongoing).

In some embodiments, a minimum flight distance capability (and/or a minimum flight time capability) condition is used in the selection of the replacement UAV 105. As a specific example, the UAV 105 with the highest battery level that also has the desired characteristics (e.g., sensor(s), hardware, etc.) and is closest to the UAV 105A may be selected to replace the UAV 105A. The replacement UAV 105 can be selected by determining, from all candidate UAVs 105 that could replace the UAV 105A, a first subset of UAVs 105 that includes all of the UAVs 105 with the desired capabilities. For example, if the mission is to provide a perpetual stare video feed, then the first subset of UAVs 105 would include all of the UAVs 105 that have the necessary hardware and software to provide the perpetual stare video feed. The UAV 105 in the first subset that has the highest battery level can then be selected as the replacement UAV 105.

In some embodiments, the candidate UAV 105 with the desired capabilities and the largest expected flight time after it replaces the UAV 105A is selected as the replacement UAV 105. With reference to FIG. 4C, if all of the UAV 105A, UAV 105B, UAV 105C, and UAV 105E are assumed to be identical (e.g., same model, same hardware, same software), the UAV 105B may be selected as the replacement UAV 105 if it is determined that after it has flown to the replacement location, its expected flight time will be higher than the corresponding expected flight time of either the UAV 105C or the UAV 105E after flying to the replacement location. In other words, if the expected flight time for a UAV 105x once it reaches the position at which it will carry out (at least a part of) the mission is denoted as E{T_{105X}}, then, in some embodiments, if E{T_{105B}}≥E{T_{105C}} and E{T_{105B}}≥E{T_{105E}}, the UAV 105B is selected as the replacement UAV 105; if E{T_{105C}}≥E{T_{105B}} and E{T_{105C}}≥E{T_{105E}}, the UAV 105C is selected as the replacement UAV 105; and if E{T_{105E}}≥E{T_{105B}} and E{T_{105E}}≥E{T_{105C}}, the UAV 105E is selected as the replacement UAV 105. It is to be appreciated that this approach can be generalized when there are more than three candidate replacement UAVs 105. Furthermore, it is to be appreciated that in the case that E{T_{105B}}=E{T_{105C}}=E{T_{105E}} (e.g., the expected flight times once reaching the replacement location are substantially equal for all of the candidate replacement UAVs 105), any of the candidate replacement UAVs 105 could be selected as the replacement UAV 105.

Thus, the replacement UAV 105 can be selected by determining, from all candidate UAVs 105 that could replace the UAV 105A, a first subset of UAVs 105 that includes all of the UAVs 105 with the desired capabilities (e.g., to provide a perpetual stare with video feed as described above, to sense a particular type of data, etc.). The UAV 105 in the first subset that has the longest expected flight time after it has flown to the replacement location can then be selected as the replacement UAV 105.

In some embodiments, the replacement UAV 105 is selected based in part on its expected flight time meeting or exceeding a threshold. For example, if it is desirable that the replacement UAV 105 fly the mission for at least 15 minutes after beginning the (segment of) the mission once it has reached the position at which it will begin to carry out (at least a part of) the mission, then any of the UAVs 105 whose expected flying time is at least 15 minutes after reaching the replacement location can be selected as the replacement UAV 105.

Thus, the replacement UAV 105 can be selected by determining, from all candidate UAVs 105 that could replace the UAV 105A, a first subset of UAVs 105 that includes all of the UAVs 105 with the desired capabilities. For example, if the mission is to provide a perpetual stare video feed, then the first subset of UAVs 105 would include all of the UAVs 105 that have the necessary hardware and software to provide the perpetual stare video feed. A second subset of UAVs 105 can then be determined as the group of one or more UAVs 105 within the first subset whose expected flight times after reaching the location of the UAV 105A meet or exceed the threshold. In the case that multiple UAVs 105 in the second subset meet the condition, one of the UAVs 105 can be chosen from the second subset at random or based on another criterion (e.g., any or all of total lifetime usage, anticipated likelihood of failure of each of the UAVs 105, known minor differences in flight behavior between UAVs 105, known differences in communication behavior/quality between UAVs 105 (e.g., differences in strength or signal-to-noise ratio of signals received from UAVs 105), pilot preferences (e.g., model, brand, color, trade dress, etc.)).

The decision as to which of the UAVs 105 in the UAS 100 will replace the UAV 105A (the UAV 105 currently flying the mission) can be made on the fly by the ground station 200, by the returning (replaced) UAV 105, by the replacement UAV 105, by any of the other UAVs 105 in the UAS 100, and/or by the recharging stations 250 without the involvement of the pilot or any other human being. This decision can be made unilaterally by one component of the UAS 100 (e.g., by the ground station 200, by the UAV 105A, by another of the UAVs 105, by one of the recharging stations 250), or it can be made jointly by two or more components (e.g., by the ground station 200 and the UAV 105A, by the ground station 200 and the candidate replacement UAV 105, by two or more of the UAVs 105, by the ground station 200 and at least one of the recharging stations 250, etc.).

Likewise, the decision as to which of the recharging stations 250 the returning UAV 105 will fly to for recharging can be made on the fly by the ground station 200, by the returning UAV 105, by the replacement UAV 105, by one or more of the recharging stations 250, and/or by any of the other UAVs 105 in the UAS 100 without the involvement of the pilot or any other human being. This decision can be made unilaterally by one component of the UAS 100 (e.g., by the ground station 200, by the UAV 105A, by another of the UAVs 105, or by one of the recharging stations 250), or it can be made jointly by two or more components (e.g., by the ground station 200 and the UAV 105A, by the ground station 200 and the candidate replacement UAV 105, by two or more of the UAVs 105, by the ground station 200 and at least one of the recharging stations 250, etc.).

In some embodiments, the ground station 200 coordinates the replacement of UAVs 105 and/or manages usage of the recharging stations 250. In some such embodiments, the ground station 200 is in communication with the UAV 105A and at least a portion of the other UAVs 105 in the UAS 100 (e.g., those UAVs 105 with sufficient battery levels to communicate successfully with the ground station 200). In some embodiments, the ground station 200 is in communication with the UAV 105A and at least a portion of the recharging stations 250. In some embodiments, the ground station 200 retrieves information from the UAVs 105 and/or the recharging stations 250. For example, the ground station 200 can retrieve information about battery charge levels and/or other status information (e.g., self-test reports, responses to status or test data requests, weather information, flight conditions, etc.) from the UAVs 105 and/or the recharging stations 250. The ground station 200 can analyze the collected information and determine which of the candidate UAVs 105 will replace the UAV 105A. The ground station 200 can send flight information (e.g., a flight plan) to the replacement UAV 105 (possibly via one of the recharging stations 250), and the replacement UAV 105 can then fly to the desired location.

The ground station 200 can also determine which of the recharging stations 250 the UAV 105A will use after being replaced. This determination can be made by the ground station 200 alone or it can be made by the ground station 200 in cooperation with the recharging stations 250. Once the replacement UAV 105 is in place, the ground station 200 can instruct the UAV 105A to fly to a particular one of the recharging stations 250. In some embodiments, the selection of the recharging station 250 to be used by the UAV 105A is based on information gathered from the UAVs 105, information gathered from the recharging stations 250, and/or information stored by the ground station 200 (e.g., a table indicating which UAVs 105 are at which recharging stations 250, data regarding the compatibilities of UAVs 105 with recharging stations 250, etc.). In some embodiments, the ground station 200, either by itself or in cooperation with the recharging stations 250, coordinates a redistribution of UAVs 105 among the recharging stations 250 (e.g., to accommodate the needs or limitations of a UAV 105 that has been replaced, to situate the UAVs 105 more optimally given upcoming task(s) in the mission, etc.). In some embodiments, the ground station 200 manages usage of the recharging stations 250 taking into account information about the mission (e.g., geographical coverage, flight time remaining, etc.). For example, the ground station 200 can take into account a flight path associated with the mission to ensure that the UAVs 105 are distributed appropriately to facilitate replacement of UAVs 105 as the mission continues. As a specific example, assuming the recharging stations 250 are distributed along the mission flight path, the ground station 200 can manage the usage of recharging stations 250 to ensure that UAVs 105 with appropriate capabilities (e.g., hardware, software, power level, etc.) are situated at recharging stations 250 along an upcoming leg of the flight path.

As another example of how the replacement of UAVs 105 and/or management of usage of the recharging stations 250 can be coordinated, the UAV 105A can be capable of communicating directly with one or more of the other UAVs 105 in the UAS 100 (possibly with assistance from the recharging stations 250), and one or more of the UAVs 105 can coordinate the replacement of the UAV 105A and/or manage usage of the recharging stations 250. In some embodiments, the UAV 105A determines that it needs to be replaced (e.g., its battery is depleting), and it sends a request to one or more of the other UAVs 105 and/or recharging stations 250. For example, the UAV 105A can broadcast a request for replacement (or transmit a signal that is established a priori as a replacement-request signal) that can be received by multiple UAVs 105 and/or recharging stations 250. As an alternative to sending a broadcast message or signal that is directed to all of the UAVs 105 and/or recharging stations 250, the UAV 105A can send a request or signal to a subset of the UAVs 105 and/or recharging stations 250 (e.g., all of the other UAVs 105 that would be suitable replacements (e.g., same model, same hardware, same software) and/or all of the recharging stations 250 the UAV 105A can use). The replacement request can be, for example, a pre-established signal or a message formatted in accordance with a pre-established message protocol. The replacement request may be transmitted at a known frequency, which, to mitigate jamming and/or nefarious interference, may change during the mission. For example, replacement requests during a mission may be transmitted at frequencies that appear to be random but in fact follow a pre-established pattern (e.g., using a sequence of frequencies determined by a pseudo-random sequence generator). The UAVs 105 and/or recharging stations 250 that received the replacement request can then coordinate amongst themselves to determine which of them will replace the UAV 105A. For example, one of the UAVs 105 can announce (e.g., via a broadcast message) that it will replace the UAV 105A. As another example, one or more of the UAVs 105 can announce (e.g., via a broadcast message) that it will not replace the UAV 105A. As another example, the UAVs 105 and/or recharging stations 250 can exchange information with each other and agree on which of the UAVs 105 will replace the UAV 105A (e.g., by choosing the UAV 105 that has the highest battery level and has the requisite hardware and software, etc.).

As an alternative to sending a broadcast message or signal that is not directed to any of the UAVs 105 in particular, the UAV 105A can send an addressed request or signal to a particular one of the UAVs 105 (e.g., a UAV 105 that is known to be a suitable replacement for it) and/or to a particular one of the recharging stations 250. The addressed request or signal may include, for example, an identifier (e.g., a MAC address, serial number, etc.) that identifies the UAV 105 (or UAVs 105) and/or recharging station(s) 250 that is (are) the intended recipient(s). The addressed request or signal may include a message that is formatted according to a pre-established protocol (e.g., a packet protocol). The message may include, for example, a header and information about the status of the UAV 105A (e.g., its current battery level, estimated remaining flight time, location, flight direction, altitude, etc.).

In some embodiments, the UAV 105A commands another one of the UAVs 105 to replace it (e.g., by sending an addressed signal or message to inform the receiving UAV 105 (possibly through one of the recharging stations 250) that it has been selected as the replacement UAV 105). In some embodiments, the UAV 105A negotiates with one or more of the other UAVs 105 (possibly via the recharging stations 250) to request a replacement. In some embodiments, the UAV 105A requests replacement, and two or more of the other UAVs 105, the recharging stations 250, and/or the ground station 200 determine which particular UAV 105 will replace the UAV 105A.

It will be appreciated from the disclosures herein that there are many ways the UAS 100 can manage usage of the UAVs 105 and the recharging stations 250 to provide a virtual UAV so that the pilot can be relieved of the responsibility and can focus on the mission. For example, as explained above, the usage of recharging stations 250 can be managed without the pilot's involvement. UAVs 105 that are being replaced can be routed to recharging stations 250 based on the occupancy and locations of the recharging stations 250, the remaining battery life or flight time of the UAV 105 being replaced, and/or any other criterion. The criterion (or criteria) used to determine usage of the recharging stations 250 and replacement of UAVs 105 flying a mission can be dynamic and can reflect current conditions (e.g., the criterion/criteria may be different when the wind is gusting and 90 minutes remain in the mission from the criterion/criteria when the wind is calm and only 5 minutes remain in the mission). A UAV 105 flying a mission may be replaced sooner if it has to fly further or under taxing conditions to a recharging station 250. Thus, the pilot does not have to set any threshold for the battery level or battery depletion that triggers replacement of the UAV 105 flying a mission. Instead, the UAS 100 decides when to replace the UAV 105.

In addition to managing usage of the recharging stations 250, handling when to replace UAVs 105 flying a mission, and/or determining which UAV 105 will replace the UAV 105A currently flying the mission, the UAS 100 can autonomously manage the mechanics of the replacement (e.g., the flight path flown by the replacement UAV 105 and the flight path flown by the UAV 105A) so as to allow a smooth transition from the UAV 105A to the replacement UAV 105 and to avoid collisions. This aspect of virtual UAV management can be handled in a variety of ways. For purposes of explanation, and with reference to FIG. 4C, it is assumed that the UAV 105B is selected to replace the UAV 105A. In some embodiments, the ground station 200 determines an appropriate flight plan for the UAV 105B and sends that flight plan to the UAV 105B (e.g., directly or via the recharging station 250B, which then provides the flight plan to the UAV 105B). The flight plan may include, for example, information identifying a pre-defined mission, thrust and direction settings, a start time, or any other information that the UAV 105B might use to navigate from the recharging station 250B to the location where it will take over the mission. Similarly, in some embodiments, the ground station 200 determines an appropriate flight plan to route the UAV 105A to the selected recharging station 250 or another location (e.g., to replace a UAV 105C), and sends the flight plan to the UAV 105A. For the sake of example, assume that the UAV 105A will return to the recharging station 250A. Because the ground station 200 establishes flight plans for both the UAV 105A and the UAV 105B, it can ensure that the UAV 105A and the UAV 105B do not collide during the swap operation. The ground station 200 can also ensure that the UAV 105A and the UAV 105B execute their respective flight plans at the appropriate times (e.g., at specified times or after specified delays). For example, the ground station 200 can ensure that the UAV 105B executes its flight plan before the UAV 105A executes its flight plan. The ground station 200 can, for example, instruct the UAV 105B to execute its flight plan after a first delay, and instruct the UAV 105A to execute its flight plan after a second delay that is larger than the first delay. Alternatively, the ground station 200 can instruct the UAV 105B to execute its flight plan at a first time, and instruct the UAV 105A to execute its flight plan at a second time that is after the first time. The UAV 105A and the UAV 105B can then execute their flight plans as instructed (e.g., after the respective specified delays or at the respective specified times). Thus, the ground station 200 can ensure that the UAV 105B is in a specified location and is flying the mission before the UAV 105A returns to the recharging station 250A.

In determining flight plans for UAVs 105, the ground station 200 can take into account any relevant information. For example, the ground station 200 can take into account one or more current conditions, such as, for example, a weather condition (e.g., temperature, humidity, wind velocity, etc.), a battery level of the UAV 105A and/or UAV 105B, a position of the UAV 105A and/or UAV 105B, occupancy of the recharging stations 250, a position of a particular recharging station 250, or presence or absence of an object or event detected by the UAV 105A, the UAV 105B, and/or a source external to the UAS 100.

In some embodiments, the ground station 200 also manages the timing of the transition of data collection (and/or provision) from the UAV 105A to the UAV 105B. For example, once the UAV 105B has executed its flight plan, the ground station 200 can send an instruction to the UAV 105B to begin collecting data and/or sending data to the ground station 200. Once the ground station 200 confirms it is receiving data from the UAV 105B (and/or that the UAV 105B is collecting data), the ground station 200 can instruct the UAV 105A to stop collecting and/or sending data and execute its flight plan. Thus, the ground station 200 can manage the switchover from the UAV 105A to the UAV 105B. For example, if the UAV 105A is providing a video feed to the ground station 200, the ground station 200 can manage when the UAV 105A stops providing that video feed and when the UAV 105B starts providing a video feed. In general, the ground station 200 can verify that the UAV 105B is in position to replace the UAV 105A, and then switch a feed (e.g., video, data, control, etc.) from the UAV 105A to the UAV 105B.

In some embodiments, the UAV 105A and the UAV 105B are configured to communicate with each other to carry out the replacement without colliding and/or to exchange other information (e.g., the UAV 105A can inform the UAV 105B about what it is doing, status of the mission, etc.). In some embodiments, the UAV 105A and UAV 105B are configured to maintain at least a specified separation distance between them during a replacement. The UAV 105A and the UAV 105B can use any of the techniques described above to maintain the specified separation distance.

During a replacement maneuver, the UAV 105A and the UAV 105B can communicate directly or through the ground station 200, which can relay messages between the UAV 105A and the UAV 105B. In some embodiments, the ground station 200 instructs the UAV 105B to replace the UAV 105A, and the UAV 105A and UAV 105B execute maneuvers to carry out the replacement without further involvement of or assistance from the ground station 200.

With reference to FIG. 4C, and assuming again that the UAV 105B is selected to replace the UAV 105A, the UAV 105A and the UAV 105B can communicate directly to coordinate the replacement. For example, if the UAV 105A is providing a video feed for a perpetual stare, the UAV 105A can communicate its location and angle of its camera. The UAV 105B can fly to a nearby location, determine the appropriate camera angle from that location, and confirm to the UAV 105A that it has acquired the target. The UAV 105A can then hand over responsibility for providing the video feed to the UAV 105B and fly back to one of the recharging stations 250. Because the UAV 105A knows where the UAV 105B is and what it is doing, the UAV 105A can fly away from the UAV 105B without causing a collision and without interrupting its data collection or provision (e.g., flying in the field of view of the camera or sensors of the UAV 105B). The UAV 105A and/or the UAV 105B can inform the ground station 200 that the change is taking place and/or has taken place. The ground station 200 can then update locally-kept records to reflect the change (e.g., to estimate or track how much flight time is expected before the UAV 105B will need to be recharged). In addition or alternatively, before handing over responsibility for the mission to the UAV 105B, the UAV 105A can provide details about the mission (e.g., status, objectives, etc.) to the UAV 105B. For example, if the UAV 105A is monitoring (or following) a moving target, it can send information about the moving target (e.g., its size, current location, detected speed, direction of travel, etc.) to the UAV 105B during the handover. In the discussion above, it is assumed that only one UAV 105 is flying a mission at a time. In some embodiments, multiple UAVs 105 are jointly flying a mission, and the UAS 100 manages the logistics. For example, two or more UAVs 105 may be jointly executing a mission. For example, a UAV 105A could be providing optical images or video, and a UAV 105B could be providing heat maps. The UAV 105A and the UAV 105B, and replacement of them by other UAVs 105 as the mission progresses, can be handled using the disclosures herein. For example, the techniques described above in Section D can be used to reduce uncertainty in locations as the UAV 105A and UAV 105B fly the mission (e.g., in a GPS-denied environment). As another example, the UAS 100 can manage the replacement of UAVs 105 and the usage of recharging stations 250 as described above, without pilot involvement. It will be appreciated that the ability of the UAS 100 to autonomously manage the UAVs 105 without pilot involvement substantially improves the pilot experience and the safety and likelihood of success of the overall mission.

As described above, once a UAV 105 has been replaced by another UAV 105, the replaced UAV 105 can fly to a recharging station 250 and recharge without human intervention. For example, the ground station 200 can instruct the replaced UAV 105 to fly to a selected recharging station 250 (e.g., a particular one of the recharging stations 250 in the UAS 100). Assuming the UAV 105A is the returning UAV 105, there are many ways for the returning UAV 105A to guide itself into position to be recharged. For example, the UAV 105A can use an onboard optical camera to land on the selected recharging station 250. Alternatively or in addition, the UAV 105A can use thermal sensing to detect the recharging station 250. Alternatively or in addition, the recharging stations 250 can include hardware and/or software to detect and guide UAVs 105 in its vicinity into position to be recharged. There are many other ways the returning UAV 105A can be directed or direct itself to the selected recharging station 250, and the examples provided herein are not intended to be limiting.

Furthermore, there are many ways the recharging stations 250 can recharge the UAVs 105. For example, they can use a physical connector, inductive charging, or any other charging method. The examples herein are not intended to be limiting.

Although the discussion above uses the depletion of the battery of a UAV 105A (or the expected depletion of the battery) as a condition prompting the UAS 100 to replace that UAV 105A, it is to be appreciated that the UAS 100 can choose to replace the UAV 105A for any reason. For example, a mission may begin with the UAS 100 gathering a first type of data (e.g., optical data, such as photos or video), and, during the execution of the mission, the UAS 100 may determine that alternative or additional data (e.g., heat maps, radar data, LiDAR data, audio data, etc.) would be useful. If the UAV 105A is not capable of gathering the alternative or additional data, the UAS 100 may decide to replace the UAV 105A with another UAV 105 that can provide the data, even if the battery level of the UAV 105A would allow it to continue flying for a long time. For example, assume the UAV 105A is following a vehicle from above and is providing a video feed of the vehicle. If the UAV 105A detects the vehicle entering a parking garage, the UAV 105A might no longer be able to provide video of the vehicle. The UAS 100 might decide to replace the UAV 105A with a UAV 105B that has a thermographic camera or infrared sensor. Thus, the UAS 100 might coordinate replacement of the UAV 105A for a reason other than its battery level.

With respect to the timing of the replacement, in some embodiments, the UAS 100 is capable of predicting and preparing for the replacement of a UAV 105 for any of a variety of reasons. Using the vehicle example above, if the UAS 100 is able to predict that the vehicle will be entering the parking garage (e.g., if the UAS 100 knows from following the vehicle in the past that it often or always enters the parking garage, or the UAS 100 has a reason to suspect that the vehicle will enter the parking garage), the UAS 100 can predict that it will want to replace the UAV 105A by the UAV 105B. The UAS 100 can predict when the replacement should take place (e.g., based at least in part on data from the UAV 105A, such as, for example, the speed and heading of the UAV 105A, the heading and/or estimated speed of the vehicle, etc.), and the UAS 100 can send the UAV 105B to the switch-over location before the UAV 105A even arrives. The ability of the UAS 100 to coordinate replacement of UAVs 105, for whatever reason it determines, can be useful both for piloted missions and for missions that extend for long periods of time. For example, if the mission is over a large and dangerous area (e.g., near a chemical spill, over a large body of water, etc.) and will take many hours, the UAS 100 can perform the mission without constant or consistent human involvement. Thus, entire missions can be performed without constant or consistent pilot supervision or management.

Accordingly, in general, the UAS 100 can replace UAVs 105 for any reason.

FIG. 4D is a flow diagram illustrating a method 400 that can be performed without human assistance (autonomously) during a mission by a UAS 100 in accordance with some embodiments. The UAS 100 performing the method 400 includes a plurality of UAVs 105 and at least one recharging station 250.

Optionally, it can also include a ground station 200. At block 402, the method 400 begins. Optionally, at block 404, information is retrieved from a UAV 105A (e.g., a first UAV, referred to as “UAV1” in FIG. 4D). The retrieved information can include any information gathered by or available to the UAV 105A.

Examples include information about at least one of: a battery level, a power level, an estimated flight time, an observation, a target, a landmark, or a temperature. In some embodiments, this information is retrieved by a ground station 200 of the UAS 100.

Optionally, at block 406, the UAV 105A requests replacement. If made, this request can prompt the execution of block 410, described further below. In other words, if block 406 occurs, block 410 can be executed in response to block 406.

Optionally, at block 408, the UAV 105A and the replacement UAV 105B (e.g., a second UAV, referred to as “UAV2” in FIG. 4D) communicate with each other. As described above, the UAV 105A and UAV 105B can communicate with each other for a variety of reasons, such as, for example, to maintain a separation distance during the replacement operation, to provide information about the mission or current conditions, to coordinate maneuvers for the replacement operation, etc. As explained above, the UAV 105A and UAV 105B may communicate directly or through another entity, such as another UAV 105, a piece of equipment (e.g., a router or gateway), or a ground station 200, which can relay messages between UAVs 105.

At block 410, the UAV 105A, which is flying the mission, is replaced by the UAV 105B without human intervention or assistance. The UAV 105B can have the same capabilities as the UAV 105A, or its capabilities can be different. Any data or information or condition can be used to trigger the replacement of the UAV 105A by the UAV 105B. For example, causing the UAV 105A to be replaced by the UAV 105B can be based at least in part on one or more of: a battery level of the UAV 105A, a power level of the UAV 105A, an estimated flight time of the 105A//, an observation, a target, a landmark, or a temperature.

In some embodiments, an activation signal (e.g., transmitted by a ground station 200 to the UAV 105B, transmitted by the UAV 105A, etc.) is used to cause the UAV 105A to be replaced by the UAV 105B. If used, the activation signal can be transmitted for any suitable reason, such as, for example, in response to at least one of: a detected battery level of the UAV 105A, an estimated battery level of the UAV 105A, an elapsed amount of time, an estimated remaining flight time of the UAV 105A, an estimated remaining flight time in the mission, an estimated remaining flight distance in the mission, a predicted position of a target, or a predicted arrival time of the target.

In some embodiments, information gathered by the UAS 100 prior to the beginning of a mission is used to cause the UAV 105A to be replaced by the UAV 105B. Such information can include any information gathered by the UAS 100 before the mission, such as, for example, data from a sensor, geographic data, or information about at least one of: a battery level, a power level, a flight time, an observation, a temperature, a rate of battery depletion, an object, a landmark, or a route taken by a target.

In some embodiments, information gathered by the UAS 100 during the mission is used to cause the UAV 105A to be replaced by the UAV 105B. Such information can include any information gathered by the UAS 100 during the mission (e.g., from the UAV 105A or any UAV 105 that flew the mission before the UAV 105A), such as, for example, data from a sensor, geographic data, or information about at least one of: a battery level, a power level, a flight time, an observation, a temperature, a rate of battery depletion, an object, a landmark, a position occupied by a target, or a route taken by a target.

In some embodiments, a detected or predicted pattern of behavior (e.g., by a surveillance target) is used to cause the UAV 105A to be replaced by the UAV 105B.

In some embodiments, information about at least one of the UAV 105A or the UAV 105B is used to cause the UAV 105A to be replaced by the UAV 105B. Such information can include, for example, a make, a model, a serial number, a position, a battery level, a hardware configuration, an expected flight time, a software configuration, or a communication capability.

In some embodiments, information about an object or event detected by at least one of the UAV 105A, the UAV 105B, another of the UAVs 105 of the UAS 100 (if the UAS 100 includes more than the UAV 105A and the UAV 105B), or a source external to the UAS 100 is used to cause the UAV 105A to be replaced by the UAV 105B. Such information can include, for example, information about at least one of an object, a target, or a landmark.

There are many ways the replacement can occur, many of which have been described above. For example, in some embodiments, the replacement operation comprises handing over responsibility for data collection and/or provision from the UAV 105A to the UAV 105B. In some embodiments, the replacement operation comprises the UAV 105A and/or the UAV 105B executing a flight plan, which may be provided by a ground station 200 (if present). In some embodiments, a ground station 200 instructs the UAV 105B to replace the UAV 105A, and then the UAV 105A and UAV 105B carry out the replacement operation without further assistance from the ground station 200. In other embodiments, the ground station 200 (without pilot assistance) assists the UAV 105A and the UAV 105B to complete the replacement operation.

FIG. 4E is a flow diagram illustrating an example of a method 410A of causing the UAV 105A to be replaced by the UAV 105B using flight plans in accordance with some embodiments. FIG. 4E illustrates one way to effect block 410 of FIG. 4D. At block 422, the method 410A begins. At block 424, a flight plan is determined for the UAV 105A (a first UAV, referred to as “UAV1” in FIG. 4E). At block 426, a flight plan is determined for the UAV 105B (a second UAV, referred to as “UAV2” in FIG. 4E). One or both of the flight plans could be determined, for example, by a ground station 200. The block 424 and/or block 426 can take into account a current condition when determining a flight plan. Current conditions taken into account can include, for example, one or more of: a weather condition, a battery level of the UAV 105A, a battery level of the UAV 105B, a position of the UAV 105A, a position of the UAV 105B, an occupancy of the recharging station(s) 250, a position of a particular recharging station of the recharging stations 250, or presence or absence of an object or event detected by at least one of the UAV 105A, the UAV 105B, another of the UAVs 105 of the UAS 100, or a source external to the UAS 100.

At block 428, the flight plan determined for the UAV 105A is provided to the UAV 105A (e.g., by a ground station 200), and at block 430, the flight plan determined for the UAV 105B is provided to the UAV 105B (e.g., by a ground station 200). Optionally, at block 432, the UAV 105B is instructed as to when to execute its flight plan, and, optionally, at block 434, the UAV 105A is instructed as to when to execute its flight plan. For example, the UAV 105B can be instructed to execute its flight plan at a first specified time or after a first specified delay, and/or the UAV 105A can be instructed to execute its flight plan at a second specified time (e.g., after the first specified time) or after a second specified delay (e.g., a larger delay than the first specified delay). The instruction can be provided by an external entity (e.g., a ground station 200) or it can be retrieved from memory (e.g., a table or database of the UAV 105A, UAV 105B). At block 436, the UAV 105B executes its flight plan as instructed (e.g., at the first specified time, if specified, or after the first specified delay, if specified), and at block 438, the UAV 105A executes its flight plan as instructed (e.g., at the second specified time, if specified, or after the second specified delay, if specified).

At block 440, the method ends.

As explained above, the replacement operation at block 410 can include switching a feed from the UAV 105A to the UAV 105B. FIG. 4F is a flow diagram illustrating an example of a method 410B of causing the UAV 105A to be replaced by the UAV 105B when the UAV 105A is providing a feed (e.g., to a ground station 200) in accordance with some embodiments. FIG. 4F illustrates one way to effect block 410 of FIG. 4D. At block 452, the method 410B begins. At block 454, it is verified that the UAV 105B is in position to replace the UAV 105A. For example, the UAV 105A can report the arrival of the UAV 105B, or the UAV 105B can report its position to a ground station 200, etc. At block 456, in response to verifying that the UAV 105B is in position to replace the UAV 105A, a feed (e.g., control, video, data, etc.) is switched from the UAV 105A to the UAV 105B. At block 458, the method 410B ends.

Returning to FIG. 4D, optionally, at block 412, a particular recharging station of the recharging stations 250 is selected for the UAV 105A to return to. The particular recharging station can be selected autonomously (independently by the UAS 100 without pilot intervention or assistance). For example, a ground station 200 can select the particular recharging station. The choice of the particular recharging station, whether made by a ground station 200 or another component(s) of the UAS 100, can be based on information retrieved from the UAV 105A (e.g., information about at least one of: a battery level, a power level, an estimated flight time, an observation, a target, a landmark, a temperature, etc.).

At block 414, the method 400 causes the UAV 105A to fly to a particular recharging station (e.g., the recharging station selected in block 412, if executed).

At block 416, the method 400 ends.

It is to be appreciated that although some of the blocks of the method 400, the method 410A, and the method 410B are performed in the order shown (e.g., in the method 400, block 412 would be performed before block 414), others of the blocks can be performed in different orders that will be apparent to those having ordinary skill in the art. For example, it will be appreciated that in the method 400, block 406 can be performed before block 404. As another example, it will be appreciated that in the method 410A, block 424, block 426, block 428, and block 430 can be reordered (e.g., in the order block 426, block 424, block 428, block 430; or in the order block 424, block 428, block 426, block 430; etc.).

It will also be appreciated that FIGS. 4D, 4E, and 4F are provided for explanatory purposes, and that certain blocks of the method 400, the method 410A, and/or the method 410B can be combined or further divided.

It is also to be appreciated that some of the blocks of the method 400, the method 410A, and the method 410B can be performed in parallel or more than once. For example, the block 408 of the method 400 can be performed in parallel with other blocks, or communication between the UAV 105A and the UAV 105B can occur multiple times and/or be ongoing throughout the replacement operation.

### F. Using Multiple UAVs to Create a Long-Range Communication Network

In some embodiments, two or more UAVs 105 are used to implement a communication network. For example, each of the UAVs 105 can act as a radio node. The implementation of a communication network can be transparent to the user/pilot. In other words, the UAVs 105 can establish and maintain a communication network without any user involvement.

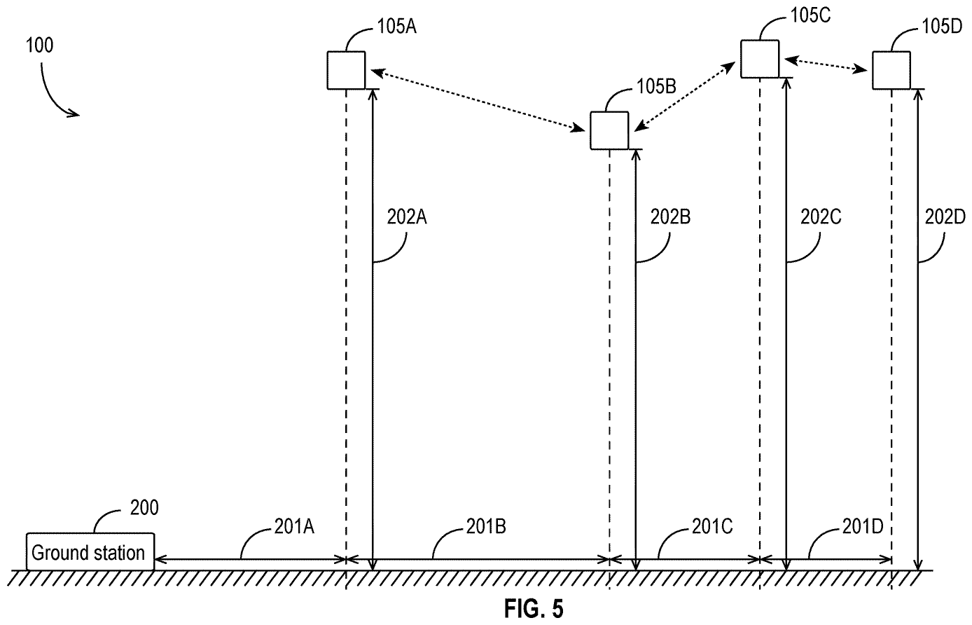

FIG. 5 is an example of a UAS 100 that includes four UAVs 105 configured to implement a communication network. In the example shown in FIG. 5, a ground station 200 communicates with a UAV 105A that is a horizontal distance 201A away from the ground station 200 and is hovering at an altitude 202A. The UAV 105A communicates with a UAV 105B that is a horizontal distance 201B away from the UAV 105A and is hovering at an altitude 202B. The UAV 105B communicates with a UAV 105C that is a horizontal distance 201C away from the UAV 105B and is hovering at an altitude 202C. The UAV 105C communicates with a UAV 105D that is a horizontal distance 201D away from the UAV 105C and is hovering at an altitude 202D. The distances 201A, 201B, 201C, and 201D may be the same as or different from each other. Similarly, the altitudes 202A, 202B, 202C, and 202D may be the same or different from each other. The altitudes 202A, 202B, 202C, and 202D may be substantially stationary, or they may change (e.g., to improve signal quality).

In some embodiments, a first subset of UAVs 105 in a UAS 100 are collecting data or identifying targets (i.e., they are “working UAVs 105”), and a second subset of UAVs 105 implements a communication network (e.g., to relay data collected by the working UAVs 105, to convey control signals to/from the working UAVs 105, etc.) (i.e., they are “communication UAVs 105”).

In some embodiments, each of the UAVs 105 in a UAS 100 is capable of being either a working UAV 105 or a communication UAV 105.

In some embodiments, the UAVs 105 that are communication UAVs 105 are capable of autonomously configuring a communication network. For example, the communication UAVs 105 can detect signal levels and determine whether changes to the network are needed (e.g., additional nodes (repeaters) should be added or other adjustments made). The communication UAVs 105 can then coordinate the changes. For example, referring to FIG. 5, if it is determined that the signal quality between the UAV 105A and the UAV 105B has degraded, one or more of the altitudes 202A, the altitudes 202B, or the horizontal distance 201B may be adjusted to improve the signal quality.

Alternatively or in addition, an additional UAV 105 may be added to the network between the UAV 105A and the UAV 105B. Conversely, if the signal quality is sufficient and it is desirable to extend the range of the network, one or more of the horizontal distance 201A, horizontal distance 201B, horizontal distance 201C, horizontal distance 201D may be increased, and/or any of the altitudes 202A, altitudes 202B, altitudes 202C, altitudes 202D may be adjusted and/or one or more of the UAV 105A, UAV 105B, UAV 105C, UAV 105D may be removed from the network.

The communication UAVs 105 can be capable of transmitting omnidirectional or focused signals, or both omnidirectional and focused signals (either at the same time or at different times, e.g., via a user selection).

The techniques described above in Section E can be used along with the techniques described in this section. Thus, replacement UAVs 105 can fly in and replace communication UAVs 105 when necessary or desirable without a significant or noticeable interruption in communication.

### G. Using Multiple Coordinated UAVs to Gather Information

In some embodiments, a UAS 100 includes multiple UAVs 105 that carry different payloads (e.g., peripherals) and together provide all of the functionality of the UAS 100, thereby behaving as a virtual single UAV 105. For example, as described above in Section E, different UAVs 105 can carry different types of sensors to collect the desired information.

In some embodiments, a single UAV 105 is capable of carrying any of a variety of modules (e.g., a video module, a thermal module, a sonar module, etc.). Accordingly, a single UAV 105 can be designed such that it is capable of handling any one of (or a subset of) the variety of modules at a time. By carrying only one module (or fewer than all possible modules), the battery life of the UAV 105 can be extended, and the UAV 105 will typically be more maneuverable because it is lighter, etc. A team of such UAVs 105 can then be assembled, with different UAVs 105 carrying different modules such that the team in aggregate provides all of the desired sensing and/or other functionality. In other words, multiple UAVs 105 operate in coordination with each other and can appear to the user/pilot to be a single UAV 105.

In some embodiments, the team of UAVs 105 operating as a single virtual UAV 105 works in cooperation with a team of communication UAVs 105 (e.g., as described above in Section F) to send collected information to a control station (e.g., in the pilot's location) and/or to provide information to the team of UAVs 105. In some embodiments, the team of UAVs 105 operates as a virtual UAV as described above in Section E. In other words, the UAS 100 can manage the batteries of the UAVs 105 without the user/pilot being involved or even aware of this aspect of the UAS 100. In addition, or alternatively, the team of UAVs 105 can establish a communication network as described above in Section F.

In some embodiments, the team of UAVs 105 operating as a single virtual UAV 105 is managed as described above in Section E.

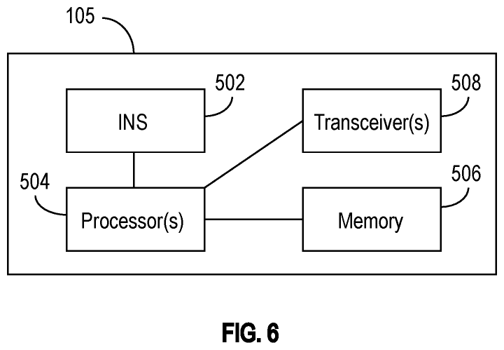

FIG. 6 is a diagram showing examples of components of that can be included in UAVs 105 that can be used to carry out the systems and methods described herein. FIG. 6 does not illustrate all of the components of a UAV 105 (e.g., rotors, sensors, motors, etc. are not illustrated). As shown in FIG. 6, the UAV 105 example includes an inertial navigation system (INS) 502. As explained previously, the INS 502 can include one or more sensors, such as accelerometers, gyros, magnetometers, static/dynamic pressure sensors, and/or any other inertial measurement units (IMUs) that take into consideration geometric and kinematic relationships. The INS 502 may include a processor, memory, and other components (not illustrated in FIG. 6).

The UAV 105 also includes at least one processor 504, which, as shown in FIG. 6, may be communicatively coupled to the INS 502 so that the at least one processor 504 can obtain data, measurements, and/or estimates from the INS 502. The at least one processor 504 is configured to execute machine-executable instructions so that the UAV 105 can participate in the systems described herein and/or to perform the methods described herein. For example, the machine-executable instructions can allow the UAV 105 to participate in autonomous replacement of UAVs 105. The at least one processor 504 may have capabilities that are helpful for implementing AI (e.g., high parallel processing performance), thereby allowing fast performance of arithmetic operations such as machine training. The at least one processor 504 can be, for example, one or more general processing units (GPUs) and/or specialized AI chips. For example, the at least one processor 504 may include a processor solely for AI, and/or it may be manufactured as a part of an existing general processor (e.g., a CPU or an application processor), and/or it may include a graphic processor (e.g., a GPU).

As shown in FIG. 6, the UAV 105 can also include memory 506, which can store the machine-executable instructions used by the at least one processor 504. The memory 506 may be coupled to the at least one processor 504 to facilitate providing the machine-executable instructions to the at least one processor 504. The memory 506 may also store data, such as, for example, local estimates of the position, orientation, and/or velocity of the UAV 105.

As also shown in FIG. 6, the UAV 105 can include at least one transceiver 508. The at least one transceiver 508 can, for example, assist the UAV 105 to communicate with other UAVs 105, and/or with one or more ground stations 200 and/or with one or more recharging stations 250. The at least one transceiver 508 can be of any suitable type or types and/or can support any suitable communication protocol. For example, the at least one transceiver 508 can support one or more of cellular, Wi-Fi, near-field, Bluetooth, Zigbee, WiMax, radio-frequency identification (RFID), satellite, infrared, or wireless sensor network communication. As illustrated, the at least one transceiver 508 may be communicatively coupled to the at least one processor 504 (e.g., such that the at least one processor 504 can cause the UAV 105 to send and/or receive signals and/or messages to/from other UAVs 105, to a ground station 200, to the recharging stations 250, etc.

In the foregoing description and in the accompanying drawings, specific terminology has been set forth to provide a thorough understanding of the disclosed embodiments. In some instances, the terminology or drawings may imply specific details that are not required to practice the invention.

To avoid obscuring the present disclosure unnecessarily, well-known components are shown in block diagram form and/or are not discussed in detail or, in some cases, at all.

Unless otherwise specifically defined herein, all terms are to be given their broadest possible interpretation, including meanings implied from the specification and drawings and meanings understood by those skilled in the art and/or as defined in dictionaries, treatises, etc. As set forth explicitly herein, some terms may not comport with their ordinary or customary meanings.

The terms “pilot” and “user” are used interchangeably herein.

As used in the specification and the appended claims, the singular forms “a,” “an” and “the” do not exclude plural referents unless otherwise specified. The word “or” is to be interpreted as inclusive unless otherwise specified. Thus, the phrase “A or B” is to be interpreted as meaning all of the following: “both A and B,” “A but not B,” and “B but not A.” Any use of “and/or” herein does not mean that the word “or” alone connotes exclusivity.

As used in the specification and the appended claims, phrases of the form “at least one of A, B, and C,” “at least one of A, B, or C,” “one or more of A, B, or C,” and “one or more of A, B, and C” are interchangeable, and each encompasses all of the following meanings: “A only,” “B only,” “C only,” “A and B but not C,” “A and C but not B,” “B and C but not A,” and “all of A, B, and C.” To the extent that the terms “include(s),” “having,” “has,” “with,” and variants thereof are used in the detailed description or the claims, such terms are intended to be inclusive in a manner similar to the term “comprising,” i.e., meaning “including but not limited to.”

The terms “exemplary” and “embodiment” are used to express examples, not preferences or requirements.

The term “coupled” is used herein to express a direct connection/attachment as well as a connection/attachment through one or more intervening elements or structures.

The terms “over,” “under,” “between,” and “on” are used herein refer to a relative position of one feature with respect to other features. For example, one feature disposed “over” or “under” another feature may be directly in contact with the other feature or may have intervening material. Moreover, one feature disposed “between” two features may be directly in contact with the two features or may have one or more intervening features or materials. In contrast, a first feature “on” a second feature is in contact with that second feature.

The term “substantially” is used to describe a structure, configuration, dimension, etc. that is largely or nearly as stated, but, due to manufacturing tolerances and the like, may in practice result in a situation in which the structure, configuration, dimension, etc. is not always or necessarily precisely as stated. For example, describing two lengths as “substantially equal” means that the two lengths are the same for all practical purposes, but they may not (and need not) be precisely equal at sufficiently small scales. As another example, a structure that is “substantially vertical” would be considered to be vertical for all practical purposes, even if it is not precisely at 90 degrees relative to horizontal.

The drawings are not necessarily to scale, and the dimensions, shapes, and sizes of the features may differ substantially from how they are depicted in the drawings.

Although specific embodiments have been disclosed, it will be evident that various modifications and changes may be made thereto without departing from the broader spirit and scope of the disclosure. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

1. An unmanned aerial system (UAS), comprising:
a plurality of unmanned aerial vehicles (UAVs), the plurality of UAVs including a first UAV and a second UAV;
at least one recharging station; and
a ground station configured to, during a mission:
autonomously coordinate replacement of the first UAV by the second UAV.

2. The UAS recited in claim 1, wherein a capability of the second UAV differs from a capability of the first UAV.

3. The UAS recited in claim 1, wherein autonomously coordinating the replacement of the first UAV by the second UAV comprises the ground station transmitting an activation signal to the second UAV.

4. The UAS recited in claim 3, wherein transmitting the activation signal is in response to at least one of:
a detected battery level of the first UAV, an estimated battery level of the first UAV, an elapsed amount of time, an estimated remaining flight time of the first UAV, an estimated remaining flight time in the mission, an estimated remaining flight distance in the mission, a predicted position of a target, an observation of the target, or a predicted arrival time of the target.

5. The UAS recited in claim 1, wherein autonomously coordinating the replacement of the first UAV by the second UAV is based at least in part on information retrieved from the first UAV.

6. The UAS recited in claim 5, wherein the ground station is further configured to retrieve the information retrieved from the first UAV.

7. The UAS recited in claim 5, wherein the information retrieved from the first UAV comprises information about at least one of: a battery level, a power level, an estimated flight time, an observation, a target, a landmark, or a temperature.

8. The UAS recited in claim 1, wherein autonomously coordinating the replacement of the first UAV by the second UAV is based at least in part on information gathered by the UAS prior to a beginning of the mission.

9. The UAS recited in claim 8, wherein the information gathered by the UAS prior to the beginning of the mission comprises data from a sensor, geographic data, or information about at least one of: a battery level, a power level, a flight time, an observation, a temperature, a rate of battery depletion, an object, a landmark, or a route taken by a target.

10. The UAS recited in claim 1, wherein autonomously coordinating the replacement of the first UAV by the second UAV is based at least in part on a detected or predicted pattern of behavior.

11. The UAS recited in claim 1, wherein autonomously coordinating the replacement of the first UAV by the second UAV is based at least in part on information about at least one of the first UAV or the second UAV.

12. The UAS recited in claim 11, wherein the information about at least one of the first UAV or the second UAV comprises a make, a model, a serial number, a position, a battery level, a hardware configuration, an expected flight time, a software configuration, or a communication capability.

13. The UAS recited in claim 1, wherein autonomously coordinating the replacement of the first UAV by the second UAV is based at least in part on information about an object or event detected by at least one of the first UAV, the second UAV, a third UAV of the UAS, or a source external to the UAS.

14. The UAS recited in claim 13, wherein the information about the object or event detected by at least one of the first UAV, the second UAV, a third UAV of the UAS, or a source external to the UAS comprises information about at least one of an object, a target, or a landmark.

15. The UAS recited in claim 1, wherein autonomously coordinating the replacement of the first UAV by the second UAV comprises:
determining a first flight plan for the first UAV;
determining second flight plan for the second UAV;
sending the first flight plan to the first UAV; and
sending the second flight plan to the second UAV.

16. The UAS recited in claim 15, wherein autonomously coordinating the replacement of the first UAV by the second UAV further comprises:
instructing the second UAV to execute the second flight plan at a first specified time or after a first specified delay; and
instructing the first UAV to execute the first flight plan at a second specified time, the second specified time being after the first specified time, or after a second specified delay, the second specified delay being larger than the first specified delay.

17. The UAS recited in claim 15, wherein the second UAV is configured to execute the second flight plan after a first specified delay, and the first UAV is configured to execute the first flight plan after a second specified delay, the second specified delay being larger than the first specified delay.

18. The UAS recited in claim 15, wherein the first flight plan includes first information instructing the first UAV when to begin executing the first flight plan, and the second flight plan includes second information instructing the second UAV when to begin executing the second flight plan.

19. The UAS recited in claim 18, wherein the first information instructs the first UAV to begin executing the first flight plan at a first time, and the second information instructs the second UAV to begin executing the second flight plan at a second time, the second time being earlier than the first time.

20. The UAS recited in claim 15, wherein determining the first flight plan for the first UAV and/or determining the second flight plan for the second UAV accounts for a current condition.

21. The UAS recited in claim 20, wherein the current condition is one or more of: a weather condition, a battery level of the first UAV, a battery level of the second UAV, a position of the first UAV, a position of the second UAV, a recharge station occupancy, a position of a particular recharge station of the at least one recharge station, or presence or absence of an object or event detected by at least one of the first UAV, the second UAV, a third UAV of the UAS, or a source external to the UAS.

22. The UAS recited in claim 1, wherein autonomously coordinating the replacement of the first UAV by the second UAV further comprises:
the ground station instructing the second UAV to replace the first UAV, and wherein the first UAV and the second UAV are configured to carry out the instruction without assistance from the ground station.

23. The UAS recited in claim 1, wherein autonomously coordinating the replacement of the first UAV by the second UAV is based at least in part on at least one of: a battery level of the first UAV, a power level of the first UAV, an estimated flight time of the first UAV, an observation a target, a landmark, or a temperature.

24. The UAS recited in claim 1, wherein the first UAV and the second UAV are configured to communicate with each other to avoid collisions and/or to transfer information.

25. The UAS recited in claim 24, wherein the first UAV and the second UAV are configured to communicate with each other through the ground station, and wherein the ground station is further configured to relay messages between the first UAV and the second UAV.

26. The UAS recited in claim 24, wherein the first UAV and the second UAV are configured to maintain at least a specified separation distance between them during a replacement operation through which the second UAV replaces the first UAV.

27. The UAS recited in claim 1, wherein autonomously coordinating the replacement of the first UAV by the second UAV comprises:
verifying that the second UAV is in position to replace the first UAV, and
switching a feed from the first UAV to the second UAV.

28. The UAS recited in claim 27, wherein the feed comprises at least one of a video feed, a data feed, or a control feed.

29. The UAS recited in claim 27, wherein autonomously coordinating the replacement of the first UAV by the second UAV further comprises:
instructing the first UAV to fly to a selected recharging station of the at least one recharging station.

30. The UAS recited in claim 1, wherein the at least one recharging station comprises a plurality of recharging stations, and wherein the ground station is further configured to, during the mission:
autonomously select a particular recharging station of the plurality of recharging stations for use by the first UAV after its replacement by the second UAV.

31. The UAS recited in claim 30, wherein one or more of the plurality of recharging stations has a variable location.

32. The UAS recited in claim 31, wherein the one or more of the plurality of recharging stations is situated in or on a vehicle.

33. The UAS recited in claim 31, wherein the one or more of the plurality of recharging stations is situated on a movable platform.

34. The UAS recited in claim 30, wherein autonomously selecting the particular recharging station of the plurality of recharging stations for use by the first UAV after its replacement by the second UAV is based at least in part on information retrieved from the first UAV.

35. The UAS recited in claim 34, wherein the ground station is further configured to retrieve the information retrieved from the first UAV.

36. The UAS recited in claim 34, wherein the information retrieved from the first UAV comprises a battery level, a power level, an estimated flight time, an observation, or a temperature.

37. The UAS recited in claim 30, wherein autonomously selecting the particular recharging station of the plurality of recharging stations for use by the first UAV after its replacement by the second UAV is based at least in part on at least one of: a battery level of the first UAV, a power level of the first UAV, an estimated flight time of the first UAV, an observation, a target, a landmark, or a temperature.

38. The UAS recited in claim 1, wherein a number of the plurality of UAVs is not equal to a number of the at least one recharging station.

39. The UAS recited in claim 38, wherein the number of the plurality of UAVs exceeds the number of the at least one recharging station.

40. The UAS recited in claim 1, wherein the plurality of UAVs includes a third UAV and a fourth UAV, and wherein the ground station is further configured to, during the mission:
autonomously coordinate replacement of the third UAV by the fourth UAV.

41. The UAS recited in claim 40, wherein each of the first UAV and the second UAV comprises a first hardware component but not a second hardware component, and wherein each of the third UAV and the fourth UAV comprises the second hardware component but not the first hardware component.

42. The UAS recited in claim 1, wherein the plurality of UAVs includes a third UAV, and wherein the ground station is further configured to, during the mission:
autonomously coordinate replacement of the second UAV by the third UAV.

43. The UAS recited in claim 1, wherein the ground station comprises:
a processor configured to execute machine-executable instructions for autonomously coordinating replacement of the first UAV by the second UAV; and
memory storing the machine-executable instructions.

44. A method performed during a mission by an unmanned aerial system (UAS) comprising a plurality of unmanned aerial vehicles (UAVs) and at least one recharging station, the method comprising, without human assistance:
causing a first UAV flying the mission to be replaced by a second UAV; and
causing the first UAV to fly to a particular recharging station of the at least one recharging station.

45. The method of claim 44, wherein causing the first UAV flying the mission to be replaced by the second UAV comprises handing over responsibility for data collection and/or provision to the second UAV.

46. The method of claim 44, wherein causing the first UAV flying the mission to be replaced by the second UAV comprises the second UAV executing a flight plan.

47. The method of claim 46, further comprising a ground station providing the flight plan to the second UAV.

48. The method of claim 44, further comprising the first UAV requesting a replacement UAV, and wherein causing the first UAV flying the mission to be replaced by the second UAV is in response to the first UAV requesting the replacement UAV.

49. The method of claim 44, wherein the at least one recharging station comprises a plurality of recharging stations including the particular recharging station, and wherein the method further comprises:
selecting the particular recharging station for the first UAV to use.

50. The method of claim 44, wherein a capability of the second UAV differs from a capability of the first UAV.

51. The method of claim 44, wherein causing the first UAV flying the mission to be replaced by the second UAV comprises a ground station transmitting an activation signal to the second UAV.

52. The method of claim 51, wherein transmitting the activation signal is in response to at least one of: a detected battery level of the first UAV, an estimated battery level of the first UAV, an elapsed amount of time, an estimated remaining flight time of the first UAV, an estimated remaining flight time in the mission, an estimated remaining flight distance in the mission, a predicted position of a target, or a predicted arrival time of the target.

53. The method of claim 44, wherein causing the first UAV flying the mission to be replaced by the second UAV is based at least in part on information retrieved from the first UAV.

54. The method of claim 53, further comprising a ground station of the UAS retrieving the information retrieved from the first UAV.

55. The method of claim 53, wherein the information retrieved from the first UAV comprises information about at least one of: a battery level, a power level, an estimated flight time, an observation, a target, a landmark, or a temperature.

56. The method of claim 44, wherein causing the first UAV flying the mission to be replaced by the second UAV is based at least in part on information gathered by the UAS prior to a beginning of the mission.

57. The method of claim 56, wherein the information gathered by the UAS prior to the beginning of the mission comprises data from a sensor, geographic data, or information about at least one of: a battery level, a power level, a flight time, an observation, a temperature, a rate of battery depletion, an object, a landmark, or a route taken by a target.

58. The method of claim 44, wherein causing the first UAV flying the mission to be replaced by the second UAV is based at least in part on a detected or predicted pattern of behavior.

59. The method of claim 44, wherein causing the first UAV flying the mission to be replaced by the second UAV is based at least in part on information about at least one of the first UAV or the second UAV.

60. The method of claim 59, wherein the information about at least one of the first UAV or the second UAV comprises a make, a model, a serial number, a position, a battery level, a hardware configuration, an expected flight time, a software configuration, or a communication capability.

61. The method of claim 44, wherein causing the first UAV flying the mission to be replaced by the second UAV is based at least in part on information about an object or event detected by at least one of the first UAV, the second UAV, a third UAV of the UAS, or a source external to the UAS.

62. The method of claim 61, wherein the information about the object or event detected by at least one of the first UAV, the second UAV, a third UAV of the UAS, or a source external to the UAS comprises information about at least one of an object, a target, or a landmark.

63. The method of claim 44, wherein causing the first UAV flying the mission to be replaced by the second UAV comprises:
determining a first flight plan for the first UAV;
determining second flight plan for the second UAV;
sending the first flight plan to the first UAV; and
sending the second flight plan to the second UAV.

64. The method of claim 63, wherein causing the first UAV flying the mission to be replaced by the second UAV further comprises:
instructing the second UAV to execute the second flight plan at a first specified time or after a first specified delay; and
instructing the first UAV to execute the first flight plan at a second specified time, the second specified time being after the first specified time, or after a second specified delay, the second specified delay being larger than the first specified delay.

65. The method of claim 63, further comprising:
the second UAV executing the second flight plan after a first specified delay; and
the first UAV executing the first flight plan after a second specified delay, the second specified delay being larger than the first specified delay.

66. The method of claim 63, wherein the first flight plan includes first information instructing the first UAV when to begin executing the first flight plan, and the second flight plan includes second information instructing the second UAV when to begin executing the second flight plan.

67. The method of claim 66, wherein the first information instructs the first UAV to begin executing the first flight plan at a first time, and the second information instructs the second UAV to begin executing the second flight plan at a second time, the second time being earlier than the first time.

68. The method of claim 63, wherein determining the first flight plan for the first UAV and/or determining the second flight plan for the second UAV accounts for a current condition.

69. The method of claim 68, wherein the current condition is one or more of: a weather condition, a battery level of the first UAV, a battery level of the second UAV, a position of the first UAV, a position of the second UAV, a recharge station occupancy, a position of a particular recharge station of the at least one recharge station, or presence or absence of an object or event detected by at least one of the first UAV, the second UAV, a third UAV of the UAS, or a source external to the UAS.

70. The method of claim 44, wherein causing the first UAV flying the mission to be replaced by the second UAV comprises:
a ground station instructing the second UAV to replace the first UAV; and
the first UAV and the second UAV carrying out the instruction without assistance from the ground station.

71. The method of claim 44, wherein causing the first UAV flying the mission to be replaced by the second UAV is based at least in part on one or more of: a battery level of the first UAV, a power level of the first UAV, an estimated flight time of the first UAV, an observation, a target, a landmark, or a temperature.

72. The method of claim 44, further comprising:
the first UAV and the second UAV communicating with each other.

73. The method of claim 72, wherein the first UAV and the second UAV communicating with each other comprises sending messages to a ground station, and wherein the method further comprises the ground station relaying the messages between the first UAV and the second UAV.

74. The method of claim 72, further comprising:
the first UAV and the second UAV maintaining at least a specified separation distance between them during a replacement operation through which the second UAV replaces the first UAV.

75. The method of claim wherein causing the first UAV flying the mission to be replaced by the second UAV comprises:
verifying that the second UAV is in position to replace the first UAV, and
switching a feed from the first UAV to the second UAV.

76. The method of claim 75, wherein the feed comprises at least one of a video feed, a data feed, or a control feed.

77. The method of claim 44, wherein the particular recharging station is one of a plurality of recharging stations, and further comprising:
autonomously selecting the particular recharging station from among the plurality of recharging stations for use by the first UAV after its replacement by the second UAV.

78. The method of claim 77, wherein autonomously selecting the particular recharging station from among the plurality of recharging stations for use by the first UAV after its replacement by the second UAV is based at least in part on information retrieved from the first UAV.

79. The method of claim 78, further comprising:
a ground station retrieving the information retrieved from the first UAV.

80. The method of claim 78, wherein the information retrieved from the first UAV comprises information about at least one of: a battery level, a power level, an estimated flight time, an observation, a target, a landmark, or a temperature.

81. The method of claim 77, wherein autonomously selecting the particular recharging station from among the plurality of recharging stations for use by the first UAV after its replacement by the second UAV is based at least in part on at least one of: a battery level, a power level, an estimated flight time, an observation, a target, a landmark, or a temperature.
